(19) United States
(12) Patent Application Publication
(10) Pub. No.: US 2022/0300664 A1
(43) Pub. Date: Sep. 22, 2022

(54) DEVICE, SOFTWARE, AND METHODS FOR ADMINISTRATIVE CONTROL OF ELECTRONIC DEVICES

(71) Applicant: SOFIA FAMILY INC., Denver, CO (US)

(72) Inventors: William Thomas Connors, Denver, CO (US); Jared Jonathon Schiltz, Denver, CO (US)

(21) Appl. No.: 17/616,064

(22) PCT Filed: Jun. 4, 2020
(86) PCT No.: PCT/US2020/036027

§ 371 Date: Dec. 2, 2021

Related U.S. Application Data
(60) Provisional application No. 62/857,222, filed on Jun. 4, 2019.
(60) Provisional application No. 62/949,982, filed on Dec. 18, 2019.

(51) Int. Cl. G06F 21/81; G06F 21/32; G06F 21/60; G06F 21/62

(52) U.S. Cl. CPC G06F 21/81; G06F 21/32; G06F 21/604; G06F 21/62; G06F 2221/2141; G06F 2221/2149

(57) ABSTRACT

An administrative control system for controlling access to one or more devices for one or more users. In at least some examples, the administrative control system utilizes an access control device (ACD) inserted into an electrical circuit to selectively control electricity (e.g., power or control signals) in an electrical circuit of one or more governed devices. In this regard, even closed devices may be subjected to control by the administrative control system. In turn, a policy regarding device use may be enforced across different devices and platforms to provide a comprehensive system for controlling access to governed devices. Further still, the system may monitor for one or more circumvention states to provide a responsive action or altering/notification in response to a circumvention state.

### CROSS-REFERENCE TO RELATED APPLICATIONS

This application is a U.S. National Stage of PCT Application No. PCT/US2020/036027 filed on Jun. 4, 2020 entitled “Device, software, and methods for administrative control of electronic devices”, which claims priority to U.S. Provisional App. No. 62/857,222 filed on 4 Jun. 2019 entitled “Device, software, and methods for administrative control of electronic devices” and U.S. Provisional App. No. 62/949,982 filed on 18 Dec. 2019 entitled “Device, software, and methods for administrative control of electronic devices,” the entirety of both of which are incorporated by reference herein in their entireties.

### BACKGROUND

Managing the time children spend on electronic devices and protecting children from harmful or otherwise undesirable digital content has become an increasingly complex problem for parents and guardians (referred to in this background section collectively as “parents”). In the not-too-distant past, children had access to a limited number of electronic devices that each served a specialized purpose. For example, a child may have had access to a television that was used for viewing programming, a radio for listening to music, a landline telephone for oral communication, and a desktop computer for word processing and accessing or sharing content over the internet. Today, children regularly use desktop computers, laptop computers, mobile smartphones, tablet computers, video game consoles, media streaming devices, televisions, electronic book readers, portable video game devices, and various other electronic devices. Moreover, the functional capabilities of many electronic devices are increasingly convergent. Desktop and laptop computers, mobile smartphones, tablet computers, video game consoles, and smart televisions now share many capabilities, including streaming media available over the internet, browsing the internet, playing video games, and audio-video communication. This is true even as each of these device types retains its relative advantages and desirability for specific uses and contexts. Moreover, some of these electronic devices are dedicated exclusively to the use of one child, whereas others are shared among multiple children and/or adults. Also, some devices access the internet exclusively over one network in the home, while others regularly access the internet over multiple networks inside and outside the home. These and other factors add complexity to the challenge of managing the time that children spend on electronic devices, and protecting children from harmful or undesirable digital content.

Computer-based electronic devices may incorporate software parental controls supplied by the manufacturer (referred to herein as “native parental controls”). Parental controls typically include time management controls and content protection controls. Time management controls seek to limit a child's access to the device and/or to specific uses of the device in some time-based manner. Content protection controls seek to provide the parent with the means of monitoring and/or restricting the content a child may access or share via the device. An electronic device with parental controls effected by any means may be called a managed device.

By their nature, the native parental controls of each managed device a child may access operate in isolation from one another. As such, native time management controls are incapable of providing parents with the means to digitally define and enforce aggregate time restrictions across the various managed devices a child may use on a regular basis. Native controls are likewise incapable of providing parents with the means of digitally monitoring and/or restricting the content a child may access or share across the various managed devices a child may use on a regular basis.

To address these challenges, multi-platform parental control software applications have been developed to provide parents with the means to digitally define and enforce a parental control policy across a variety of device types and operating systems, including desktop and laptop computers, tablet computers, and mobile smartphones. However, multi-platform parental control software applications are incompatible with many common device types, including televisions, video game consoles, media streaming devices, disc players, cable set top boxes, and audio amplifiers. This incompatibility can be due to a variety of factors, including but not limited to the policies of the device manufacturer, the operating system of the device, or the absence of hardware or software that enables the installation of software. Such computer-based and non-computer-based electronic devices that are incompatible with multi-platform parental control software may be referred to herein as closed devices. Likewise, computer-based electronic devices compatible with multi-platform parental control software may be referred to herein as open devices.

By their nature, parents must manage the parental controls of each closed device separately, in isolation from any of the other managed devices the child may use. With respect to time management, this lack of integration is not merely inconvenient for parents. It renders the task of holistically managing a child's time of access across multiple managed devices and device types so cumbersome as to be in practice not achievable through digital means.

Moreover, some closed devices (such as some televisions, video game consoles, and media streaming devices) either lack native parental controls altogether, or else have native parental controls that are inadequate to accomplish certain parental control objectives, or else fail to accomplish such objectives with sufficient efficacy and ease.

To address the challenges posed by closed devices with non-existent or inadequate native time management controls, time management devices have been created that enable parents to externally restrict access to the operation of such devices. A device whose access is digitally restricted by a separate control device may be referred to herein as a governed device.

Some time management devices function by controlling power delivery to the governed device according to time parameters defined by the parent. In some cases—such as during blocks of time when operation of the governed device is prohibited, or when a child has no allotted time available—power delivery is prevented. In other cases—such as during blocks of time when operation of the governed device is authorized, and/or when a child has allotted time available—power delivery is enabled. In still other cases—such as the moment when a child has used the entirety of their allotted time on the governed device—power delivery is interrupted. Other time management devices function in a similar fashion by controlling the delivery of a low-voltage electrical current, such as a video signal, essential to the functional operation of the governed device.

To prevent easy circumvention by the child, these time management devices may incorporate a secure mechanism that physically prevents a power cord or low-voltage cable essential to the normal operation of the governed device from being removed from the time management device.

Such time management devices encumber parents of children who use multiple managed devices with significant limitations in helping to achieve their overall parental control objectives. For example, such time management devices are themselves closed devices. Therefore, parents must manage each time management device in isolation from any of the other managed devices or device types a child may regularly use. As noted above, this lack of integration is not merely inconvenient for parents. It renders the task of holistically managing a child's time of access across multiple managed devices so cumbersome as to be in practice not achievable through digital means. Additionally, these time management devices by their nature do not address the challenge of enabling a parent to digitally monitor and/or restrict in some way the content a child may access or share through the governed device.

### SUMMARY

In view of the foregoing, the present disclosure generally relates to an improved administrative control system to facilitate improved access management to one or more devices to be accessed by users. The administrative control system may facilitate a robust system that extends access control by an administrator to open devices and/or closed devices such that a policy or other access control parameters may be applied across a number of devices to be accessed by a user whose access is to be controlled. Accordingly, the administrative control system provided herein may provide a comprehensive system for access management across devices and/or platforms whether open devices or closed devices.

In this regard, one aspect of the present disclosure includes an administrative control system. The system includes an access control device (ACD) that includes electrical connectors for electrically inserting the ACD into an electrical circuit of one or more governed devices. The ACD also includes access circuitry that controls flow of electricity through the electrical connectors for controlling the flow of electricity through the electrical circuit. The ACD also includes a computing device electronically connected to the access circuitry. The system further comprises a network connection operationally connecting the computing device of the ACD to a computer network comprising one or more network computing devices. Further still, the system includes an access module comprising software on at least one of the computing device of the ACD or the one or more network computing devices to control the access circuitry.

Another aspect includes a method of controlling access to a governed device. The method includes electrically inserting an access control device (ACD) via electrical connectors into an electrical circuit of a governed device and operationally connecting a computing device of the ACD to a computer network via a network connection of the ACD. The method also includes executing an access module access module comprising executing software on at least one of the computing device of the ACD or the one or more network computing devices for enforcing an access control policy for the governed device. In turn, the method includes controlling flow of electricity through the electrical connectors by access circuitry of the ACD for controlling the flow of electricity through the electrical circuit in response to the enforcing the access control policy for the governed device.

Still another aspect includes an administrative control system. The system includes an access control device (ACD) comprising a computing device, a network connection operationally connecting the computing device of the ACD to a computer network comprising one or more network computing devices, and an access module access module. The access module includes executing software on at least one of the computing device of the ACD or the one or more network computing devices programmed to cause transmission of a control command to a governed device that enables or disables operation based on a control policy.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein. For example, a number of implementations of the present disclosure are described in greater detail below.

Generally, the disclosure provides an access control device. In an example, the access control device may have a device body. The device body may house a circuit for controlling transmission of electrical signals between a managed device and a device resource. The circuit may include two electronic connectors; a switch in the circuit between the two electronic connectors and operable to control electrical signals between the two electronic connectors; and a detection circuit electronically coupled to and configured to monitor changes in electrical properties of the circuit. The device body may also include a network connector electronically connected to the switch and the detection circuit.

The access control device may also include a computing device electronically connected to the switch, the detection circuit and the network connector, and programmed to send and receive signals to and from the switch, the detection circuit and the network connector. The computing device may include a microprocessor. The computing device may be programmed to monitor the detection circuit and control the switch. The detection circuit may include circumvention monitoring circuitry. The access control device may include multiple detection circuits having signal monitoring circuitry. The access control device may have a wireless access point coupled to the computing device. The network connector may be electronically connected to a network comprising one or more computing devices. The electronic connectors may include HDMI ports electrically coupled by an HDMI switch chip.

Access control device may include 1, 2, 3, 4, 5, 6, 7, 8, 9, 10 or more connectors each electrically connected to a device resource and 1, 2, 3, 4, 5, 6, 7, 8, 9, 10 or more connectors each electrically connected to a managed device. A system of the disclosure may include 1, 2, 3, 4, 5, 6, 7, 8, 9, 10 or more access control devices.

The access control device may include multiple electronic connectors on a source side of the access control device and a single electronic connector on a sink (resource) side of the access control device.

Administrative control software may be stored or operating on any or all of the one or more computing devices of the system. The administrative control software may be programmed to report unauthorized access to a managed device. The reporting may include identifying a state in which a device is accessed and/or content is accessed. The computing device or devices may include a cloud computing device.

One or more of the computing devices or processors of the system may be programmed to receive messages from one or more originating clients and route the messages to one or more destination clients. The messages may, for example, be echo requests or pings. One or more processors of the system may be programmed and configured to distribute one or more message types to subscriber clients. One or more of the computing devices or processors of the system may subscribe to message types published by an access control device.

Message types published by an access control device may, for example, include status messages, command responses, and authorization requests. Message types published by an access control device may, for example, include status of connection of the governed device to the access control device as determined by the disconnection detection circuit. Message types published by an access control device may, for example, include status of power supply to the access control device.

One or more of the computing devices or processors access control device may transmit and/or receive ping to and/or from a receiving computing device of the system, wherein the pings occur at intervals, and wherein the receiving computing device may be programmed to: monitor the pings; and when a predefined number of intervals have passed without registering a ping, determine that a connection failure has occurred.

One or more of the computing devices or processors of the system may be programmed so that when a computing device or processor receives a request from a user for access to a governed device, if the computing device or processor determines that the user may be granted access to the governed device, the computing device or processor commands the access control device to cycle its internal switch to a state enabling the transmission of one or more electrical signals from the governed device to the device resource.

One or more of the computing devices or processors of the system may be programmed so that when the computing device or processor commands the access control device to cycle its internal switch to a state enabling the transmission of one or more electrical signals from the governed device to the device resource, the switch of the access control device remains in said state until the access control device detects that one or more signals from the governed device is no longer present, at which time the access control device communicates to the computing device or processor sends a message indicating that the governed device is no longer being operated by the user.

One or more of the computing devices or processors of the system may be programmed so that when the computing device or processor commands the access control device to cycle its internal switch to a state enabling the transmission of one or more electrical signals from the governed device to the device resource, the switch of the access control device remains in said state so long as the computing device or processor determines based on the conditions of a parental control policy that the active user may continue to be granted access to the governed device under.

One or more of the computing devices or processors of the system may be programmed to track and record data indicating the amount of time that the active user operates the governed device.

The administrative control software may be programmed to function as a parental control system.

The administrative control software may be programmed to cause the system to monitor data traffic through an access point and communicate that circumvention has occurred if data traffic is detected to or from a governed device if no user has gained access via the access control device.

The disclosure provides an access control device, as well as methods and systems for operating the access control device. The disclosure provides a system comprising a governed device and a computer network comprising one or more computing devices and the access control device electrically inserted via the electrical connectors into an electrical circuit of the governed device; and operationally connected to the computer network.

The disclosure provides a system comprising a governed device and the access control device electrically inserted via the one or more electrical connectors into an electrical circuit of the governed device. The disclosure provides a system comprising at least two governed devices and the access control device electrically inserted via the one or more electrical connectors into an electrical circuit of each of the at least 2, 3, 4, 5, 6, 7, 8, 9, 10 or more governed devices.

The disclosure provides an administrative control system including: one or more electrical connectors for electrically inserting the access control device into an electrical circuit of a governed device; a computing device electronically connected to; control circuitry configured to control the flow of electricity through the access control device and thereby control the flow of electricity through the electrical circuit; and circumvention monitoring circuitry configured to detect states indicative of circumvention of the access control device; and a user access interface electronically connected to the computing device.

The one or more processors of the computer network may include the computing device of the access control system; a processor on a router forming part of the network; and/or a processor on a server forming part of the network.

The access control device may have a device body. The device body may have one or more electrical connectors for electrically inserting the access control device into an electrical circuit of a governed device; a computing device electronically connected to; control circuitry configured to control the flow of electricity or signals through the access control device and thereby control the flow of electricity or signals through the electrical circuit; and circumvention monitoring circuitry configured to detect states indicative of circumvention of the access control device.

The computing device may include a microprocessor. The computing device may be electronically connected to the user access interface. The computing device may be programmed to monitor and respond to an event causing a state indicating circumvention of the data circuit by causing the access control device to deactivate the electrical circuit and the data circuit. The computing device may be programmed to monitor and respond to an event causing a state indicating circumvention of the electrical circuit by causing a communication about the event to be transmitted to an administrator either directly or through an administrative control system The computing device may be programmed to monitor and respond to an event causing a state indicating circumvention of the electrical circuit by deactivating the access control device and requiring administrator intervention to reactivate the access control device. The computing device may be programmed to monitor and respond to an event causing a state indicating circumvention of the electrical circuit by causing the access control device to deactivate the electrical circuit and the data circuit. The computing device may be programmed to respond to disconnection of an AC plug from the device as a state indicating circumvention of the circuit.

In various embodiments of the disclosure, the governed device may include one or more device types selected from the following: video game console, media streaming device, digital video disc player, satellite dish, cable modem, television tuner, television, and video display. In various embodiments of the disclosure, the governed device may include two or more of such device types. In various embodiments of the disclosure, the governed device may include three or more of such device types. In various embodiments of the disclosure, the governed device may include four or more of such device types. In various embodiments of the disclosure, the governed device may include five or more of such device types.

The access control device may be operationally connected to a computer network comprising one or more computing devices. The access control device may include a network adapter, and the computing device may be electronically connected to the network adaptor. The access control device may include a user access interface configured for permitting the user to provide a user access input wherein the computing device may be electronically connected to the user access interface. The access control device may include a wireless communicator and the computing device may be electronically connected to the wireless communicator. The wireless communicator may include a transceiver. The access control device may include an internal or backup power source comprising a power supply electrically coupled to and having sufficient power to continue to monitor the AC plug detection circuit and record information about that circuit in the computing device in the absence of power from an external power supply. The access control device may include an internal or backup power source comprising a power supply electrically coupled to and having sufficient power to power communications indicating circumvention of the electrical circuit in the absence of an external power supply. The access control device may include one or more electronic connectors for electronically inserting the access control device into an electrical circuit of a governed device. The access control device may include one or more wireless connectors for electronically inserting the access control device into an electrical circuit of a governed device. The one or more wireless connectors may include a wireless access point. The access control device may include operation monitoring circuitry configured to detect states indicative of normal operation of the access control device wherein the computing device may also be electronically connected to the operation monitoring circuitry.

The administrative control software may be programmed to control access to one or more governed devices and one or more controlled devices. The administrative control software may be programmed to enforce a content control policy for multiple governed devices via one or more access control devices in a user-specific manner. The administrative control software may be programmed to enforce a content control policy for the governed device. The administrative control software may be programmed to enforce an access control policy and a content control policy for: one or more governed devices via one or more access control devices in a user-specific manner; and one or more controlled devices. The administrative control software may be programmed to enforce an access control policy for the governed device. The administrative control software may be programmed to enforce an access control policy for: one or more governed devices via one or more access control devices in a user-specific manner; and one or more controlled devices. The administrative control software may be programmed to monitor content of the governed device electrically connected to the access control device. The administrative control software may be programmed to monitor content of: one or more governed devices electrically connected to one or more corresponding access control devices; and one or more controlled devices. The administrative control software may be programmed to transmit a control command to a controlled device that disables operation when unauthorized access has been detected. The administrative control software may include access control functions. The administrative control software may include content control functions. The administrative control software may be programmed to enforce an access control policy for multiple governed devices via one or more access control devices in a user-specific manner. The disclosure provides electronic storage media having the administrative control software stored thereon. In the system of the disclosure one or more electronic storage devices of the computer network may be storing administrative control software. In the system of the disclosure one or more processors of the computer network may be operating administrative control software. The one or more processors of the computer network may be operating administrative control software. The administrative control software may be programmed to distinguish from among multiple users, e.g., multiple users in a same room.

Circumvention monitoring circuitry may include circuitry that detects mechanical events or electrical events. The circumvention monitoring circuitry may be configured to electrically monitor for circumvention of one or more of the electrical connectors from the electrical circuit of the governed device. The circumvention monitoring circuitry may include an AC plug detection circuit and the computing device may be programmed to interpret absence of connection to an AC plug via the electrical connectors as a state indicating circumvention of the circuit.

The control circuitry may be configured to enable and/or disable the flow of electricity through the access control device. The control circuitry may include an electrical switch controlling flow of electricity or signals between two of the one or more electrical connectors and the electrical switch may be controlled by the computing device.

The one or more electrical connectors may include electrical connectors selected for a circuit which is necessary for the operation of the governed device. The one or more electrical connectors may include electrical connectors selected for a data circuit of the governed device. The one or more electrical connectors may include electrical connectors selected for a power supply circuit of the governed device. The one or more electrical connectors may include: an electrical plug for connecting the access control device to a power outlet; and an electrical receptacle for receiving an electrical plug of the governed device. The one or more electrical connectors may include: electrical connectors for a power circuit; and electrical connectors for a data circuit.

The system may include a user access interface configured for permitting users to provide a user access input.

The system may include multiple access control devices, each electrically inserted via the one or more electrical connectors of the access control device into an electrical or electronic circuit of one or more corresponding governed devices.

The user access input may include one or more of the following: alphanumeric passcode, a shape or color sequence, or a unique biological identifier. The user access input may include one or more of the following: alphanumeric passcode, a shape or color sequence, or a unique biological identifier. The user access interface may be part of the access control device. The user access interface may be provided on a computing device. The user access interface may be provided on a mobile computing device. The user access interface may be provided on a remote-control device. The user access interface may be provided on a mobile computing device. The user access interface may be separate from the access control device and communicates with the access control device. The user access interface may be provided on a computing device. The user access interface may include facial recognition capabilities, including a camera device for gathering facial recognition data, and software for distinguishing among users.

The disclosure may include a smart building system that includes aspects of the system of the disclosure system together with capabilities for monitoring and/or controlling other home appliances or systems. For example the smart building system may include capabilities for monitoring and/or controlling other home appliances or systems selected from the group consisting of locks, lights, refrigerators, freezers, thermostats, air conditioning systems, heating systems, fans, window covers, windows, window covers, vacuums, security devices, and entertainment systems. The smart building system may be controllable via a common interface together with capabilities for monitoring controlling other home appliances or smart home system components. The smart building system may be a smart home system.

### BRIEF DESCRIPTION OF THE DRAWINGS

FIG. 1 depicts a schematic view of an example administrative control system.

FIGS. 2a-2b depict schematic views of examples of administrative control system.

FIG. 3 depicts a schematic view of an example administrative control system.

FIGS. 4a-4b depict schematic views of examples of an access control device.

FIGS. 5a-5b depict additional examples of an administrative control system.

FIGS. 6 and 7 depict example interfaces for an access control device.

FIGS. 8 and 9 depict example administrative control systems with content monitoring.

FIGS. 10-11 depict example administrative control systems illustrating control over a plurality of devices including open and closed devices.

FIG. 12 depicts an example processing device to facilitate certain aspects of the present disclosure.

### DETAILED DESCRIPTION

### Definitions

As used herein, the following terms have the meanings indicated:

“Administrator” means an entity (e.g., an individual) who defines digital control policies that restrict a user's operation of a device. For example, an administrator may set time-based conditions for a user's access to a device, or to certain uses of the device. Additionally or alternatively, an administrator may restrict digital content that a user may access or share via the device. Examples of an administrator include, but are not limited to, a parent, guardian, teacher, or information technology administrator in a company or organization.

“Active user” means an individual who is currently operating a device.

“Administrative control software” means software capable of restricting the use of one or more devices according to a policy.

“Closed device” means an electronic device that is incompatible with multi-platform administrative control software. This incompatibility may be due to any number of factors, including, for example, the policies of the device manufacturer, the operating system of the device, technical or economic limitations of the software manufacturer, or the absence of hardware and/or software that enables the installation of software. Common examples of closed devices include, but are not limited to, televisions, video game consoles, media streaming devices, and audio amplifiers.

“Computing device” means a hardware processor, hardware controller, or other chip, circuit or device having the capability of processing digital instructions.

“Controlled device” means a managed device having digital control policies that are enforced by software installed on the managed device.

“Device” means an electronic device that may be used by a person. A device may or may not be computer-based. Example devices include, but are not limited to, desktop computers, laptop computers, tablet computers, video monitors, televisions, digital video disc players, media streaming devices, video game consoles, mobile smartphones, electronic readers, and portable video game devices.

“Device Resource” means an external device or peripheral upon which a managed device is dependent for functional operation. For example, gaming consoles and media streaming devices are dependent upon a television screen for functional operation.

“Electrically connected,” “electrical connection,” “electrically coupled,” and the like are intended to refer to a connection that is capable of transmitting electricity and are intended to include both wired and wireless connections, including without limitation connections that are capable of transmitting data signals, e.g., electrical signals, electromagnetic signals, and optical signals. Similarly, an electronic circuit may include electronic connections, including for example, wireless electronic connections. For example, an electronic circuit of a governed device may include any circuit required to operate, power, or communicate with the governed device, and an access control device electronically coupled into a circuit of a governed device may be coupled physically or wirelessly, e.g., regarding the latter, the access control device may operate as a wireless access point. Similarly, an electronic signal means any signal, whether transmitted electrically, optically, wirelessly, or by any other means.

“Governed device” means a managed device whose digital control policies are enforced by software installed on a separate control device that restricts a user's operation of the governed device.

“Managed device” means an electronic device whose operation by a user is controlled by digital control policies defined by an administrator. The digital control policies may be enforced through any digitally-enabled means.

“Network connection” means an electrical or electronic connection between elements of a network.

“Open device” means an electronic device that is compatible with multi-platform administrative control software.

“Operationally connected” means, with respect to a network connection, that a device is connected to elements of the network in a manner which permits them to electrically or electronically interact via the network (e.g., exchange communications in the form of data or other electrical or electromagnetic signal).

“Policy” means a set of rules defining permitted and/or restricted uses of a managed device. Such rules may, for example, be based on time, content, specific applications, application types, or any other condition of interest to an administrator. Such rules may or may not be user-specific. Examples of policies include access control policies, content control policies, and parental control policies. In one aspect of the present disclosure, the policies of the disclosure include rules for all multiple types of managed devices. In another aspect, the policies may include both access control policies and content control policies. In another aspect, the policies may include rules for multiple types of managed devices; and may include both access control policies and content control policies.

“Access Control Policy” means a policy that restricts access to one or more uses of a device for one or more users, based on conditions defined by an administrator.

“Content Control Policy” means a policy that restricts access to content that may be accessed by a device for one or more users, based on conditions defined by an administrator.

“Parental Control Policy” means a policy defined by a parent or guardian that restricts how a child may use a managed device. A parental control policy may include access control policies and/or content control policies.

“Restricted user” means an individual whose operation of a device is restricted in some way by an administrator.

“Software” includes firmware, operating systems, applications and other types of software.

“User” means an individual who may operate a device.

In one embodiment, the present disclosure provides an access control device for restricting the operation of a governed electronic device.

The present disclosure also provides systems incorporating the access control device and methods of using the access control device for restricting access to a governed device. The access control device enables an administrator, such as a parent, to digitally define and enforce conditions for the access of one or more users to a governed device requiring an electrical connection. In some cases, the access control device controls power delivery to a governed device requiring external power, such as a television, video game console, or media streaming device. In some cases, the access control device controls the transmission of an electrical signal required to operate the governed device, such as the output connection to a video display, or an input connection from a keyboard or other controller. In some cases, the access control device sends control commands to a governed device that disable operation when unauthorized access has been detected.

The disclosure also provides systems, software, and/or methods that enable administrators, such as parents, to digitally monitor and/or restrict the content a restricted user, such as a child, may access or share via a governed device. The systems, software and methods of using the access control device may be employed to enable the digital enforcement of a parental control policy for a single governed device, or in conjunction with any number of additional managed devices.

Systems of the present disclosure may incorporate the access control device into a networked system that permits monitoring the device, controlling the device, and providing communications to administrators and users about the device.

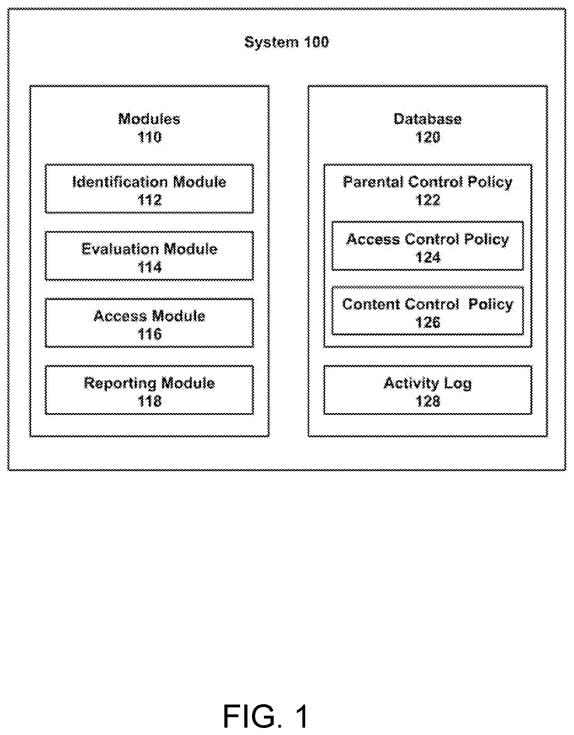

FIG. 1 is a block diagram of an exemplary system (100) suitable for the operation of the present disclosure for digitally enforcing administrative controls of electronic devices. The system (100) may include one or more modules (110) for performing tasks. For example, modules (110) may include an identification module (112) for identifying an administrative control policy, in this case parental control policy (122), that governs the use of one or more managed devices by a user. Modules (110) may include an evaluation module (114) for evaluating whether an action attempted by a user is permitted under the parental control policy (122). Modules (110) may include an access module (116) for granting or restricting access in some way based upon the permissibility of the attempted action under the conditions of the parental control policy (122), as determined by the evaluation module (114). Modules may include a reporting module (118) for communicating information about the activities attempted or accomplished by a user. The system (100) may also include a database (120). For example, a database (120) may contain a parental control policy (122) associated with a user, and an activity log (128) that contains a record of the actions attempted or accomplished by a user on one or more managed devices. The parental control policy (122) may contain an access control policy (124) and/or a content control policy (126). Part or all of this system (100) may be installed on a remote server, a local router, a managed device, or a device that governs a managed device.

### Access Control Device

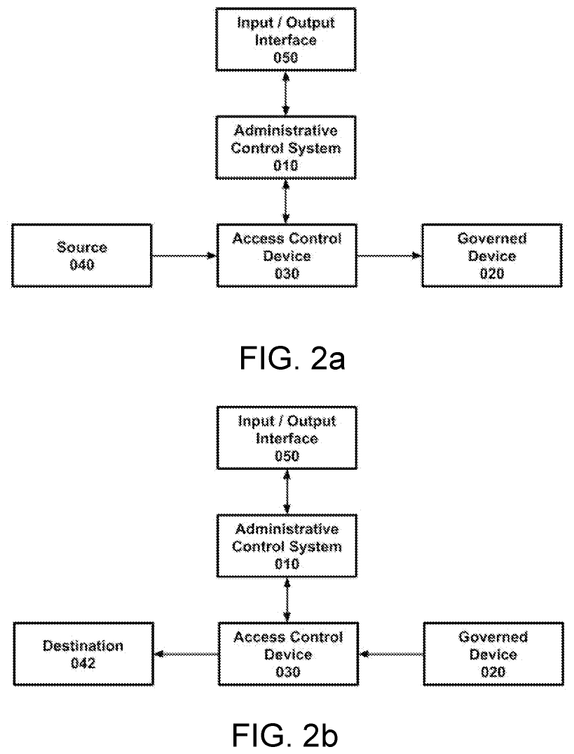

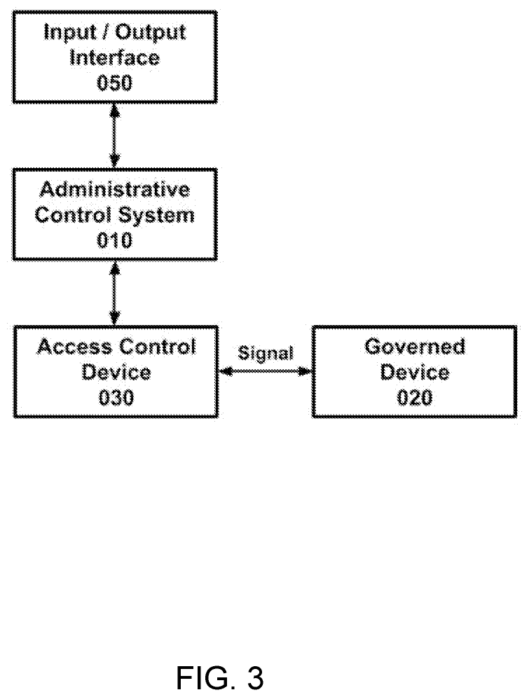

As shown in FIG. 2a the access control device (030) of the present disclosure may control access to a governed device (020) for one or more users by controlling the flow of electricity through the access control device (030) from a source (040) to the governed device (020). As shown in FIG. 2b, the access control device (030) of the present disclosure may also control access to a governed device (020) for one or more users by controlling the flow of electricity through the access control device (030) from the governed device (020) to a destination (042). As shown in FIG. 3, the access control device (030) of the present disclosure may also control access to a governed device (020) for one or more users through control commands that disable operation when unauthorized access has been detected. The governed device (020) may be a closed device or an open device.

A user provides information sufficient to gain access to the governed device (020) through an input-output interface (050) to an administrative control system (010). The administrative control system (010) may be located on the access control device (030), or on another device. If access is authorized, the administrative control system (010) commands the access control device (030) to enable the flow of an electrical current through the access control device (030), as shown in FIGS. 2a and 2b. Alternatively, the administrative control system (010) may restrict or allow access to a governed device by commanding the access control device (030) to send control commands to the governed device that disable or enable operation, as shown in FIG. 3. The access control device (030) contains circuitry and software that detects various states indicative of attempts to circumvent or disable the access control device (030). The access control device (030) of the present disclosure may be configured as a closed device, or as an open device.

In one embodiment, the access control device of the present disclosure includes without limitation the following elements:

Electrical input

Electrical output

Microprocessor

Means of user input and output

Power source

Network connection

Circuitry that enables or disables the transmission of an electrical signal

Circuitry for detecting states indicative of administrative control circumvention

In another embodiment, the access control device of the present disclosure includes without limitation the following elements:

Electrical input

Electrical output

Microprocessor

Non-volatile memory

Means of user input and output

Power source

Network connection

Circuitry that enables or disables the transmission of an electrical signal

Circuitry for detecting states indicative of administrative control circumvention

In another embodiment, the access control device of the present disclosure includes without limitation the following elements:

Microprocessor

Means of user input and output

Power source

Network connection

Circuitry capable of detecting and controlling the operational state of a governed device

Other embodiments will be readily envisioned by one of skill in the art in view of this specification.

In some cases, the electrical input and output are suitable for inserting the access control device into a circuit between an external power source and the managed device. In other cases, the electrical input and output are suitable for inserting the access control device into a circuit between the governed device and a device resource required for functional operation of the governed device, such as a television, video display, and/or A/V receiver. In other cases, the electrical input and output are suitable for enabling the access control device to communicate with a governed device for the purposes of detecting operational state and issuing control commands that disable operation.

The access control device of the present disclosure may be used in conjunction with the systems and methods shown in FIG. 1 and FIGS. 5a through 12 and described below to enforce a parental control policy (122) on a governed device, including an access control policy (124) and/or a content control policy (126).

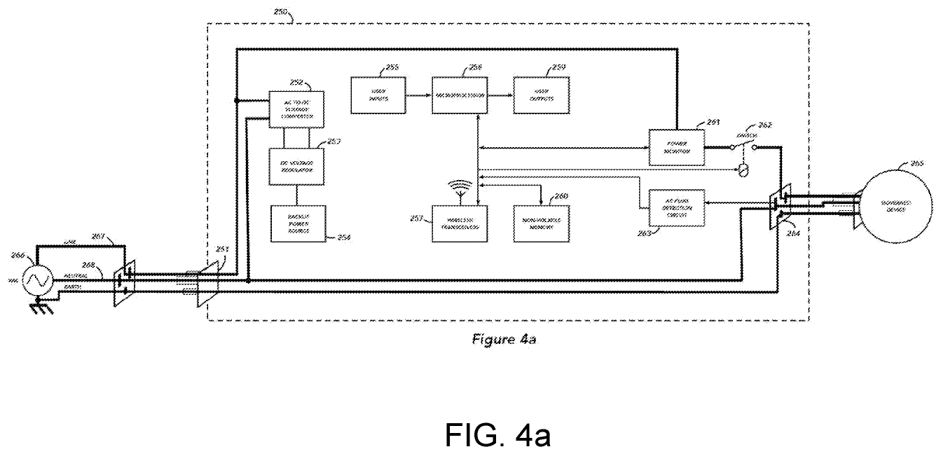

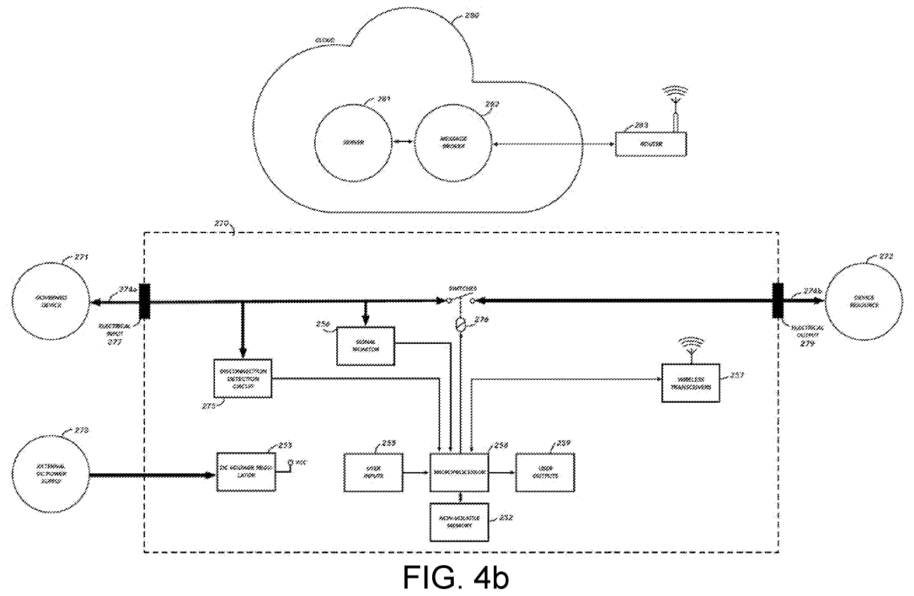

FIG. 4a is a block diagram of an exemplary design of an access control device (250) that enables a parent or other administrator to enforce a parental control policy (122) on a governed device (265) for one or more users by controlling the delivery of power from a power source (266) to the governed device (265), according to the method shown in FIG. 4a, and described below.

The exemplary design includes an electrical input (251) suitable for connection with a power source (266), an electrical output (264) suitable for connection with the governed device (265), and a power switch (262) whose default state is “OPEN”. The design also includes a microprocessor (258) for performing computing tasks, non-volatile memory (260) for storing software and data, and wireless transceivers (257) for communicating with a wireless network and/or external wireless device(s). The design further includes an AC to DC voltage converter (252) and a DC voltage regulator (253) necessary for supplying power to various device components.

Some of the parental control system (100) is located on the access control device (250), and communicates through the wireless transceivers (257) to other parts of the parental control system (100) located on a router (not shown), and/or on one or more servers (not shown).

A user provides information to the parental control system (100) satisfying conditions sufficient to gain access to the governed device (265). The parental control system (100) issues a command to the access control device (250) to cycle the power switch (262) from the “OPEN” state to the “CLOSED” state. When the power switch is in the “CLOSED” state, power is available for delivery to the governed device (265) from the power source (266) through the access control device (250).

During operation of the governed device (265), a power monitor (261) monitors the delivery of power through the access control device (250) to the governed device (265). The output of the power monitor (261) is evaluated at intervals by software on the access control device (250) that determines whether the governed device (265) continues to operate, and communicates this determination to the parental control system (100). If it is determined that the governed device (250) has ceased to operate, the access control device may cycle the power switch to the “OPEN” state.

During operation of the governed device (265), the parental control system (100) may determine that the active user should no longer have access to the governed device (265). When such a determination is made, the parental control system (100) issues a command to the access control device (250) to cycle the power switch (262) to the “OPEN” state.

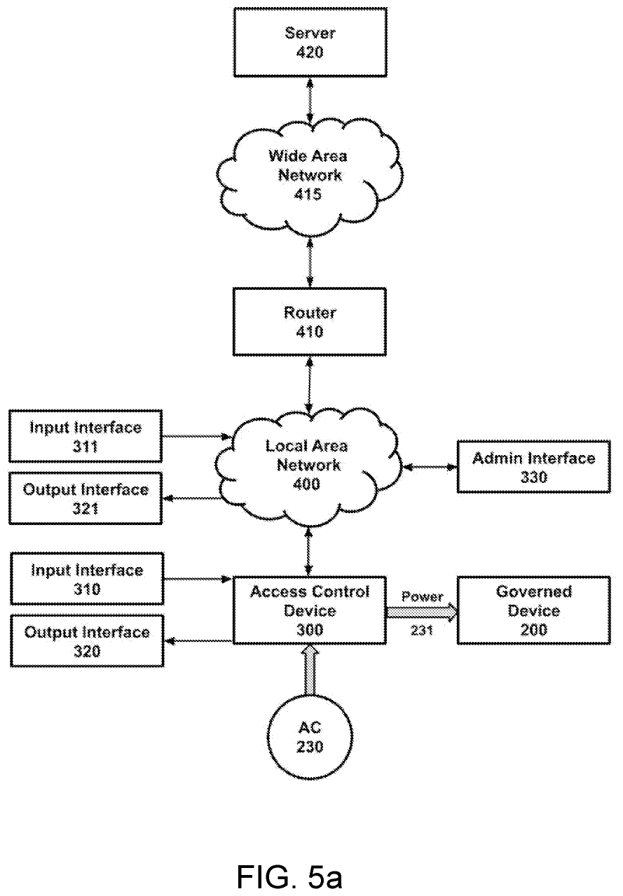

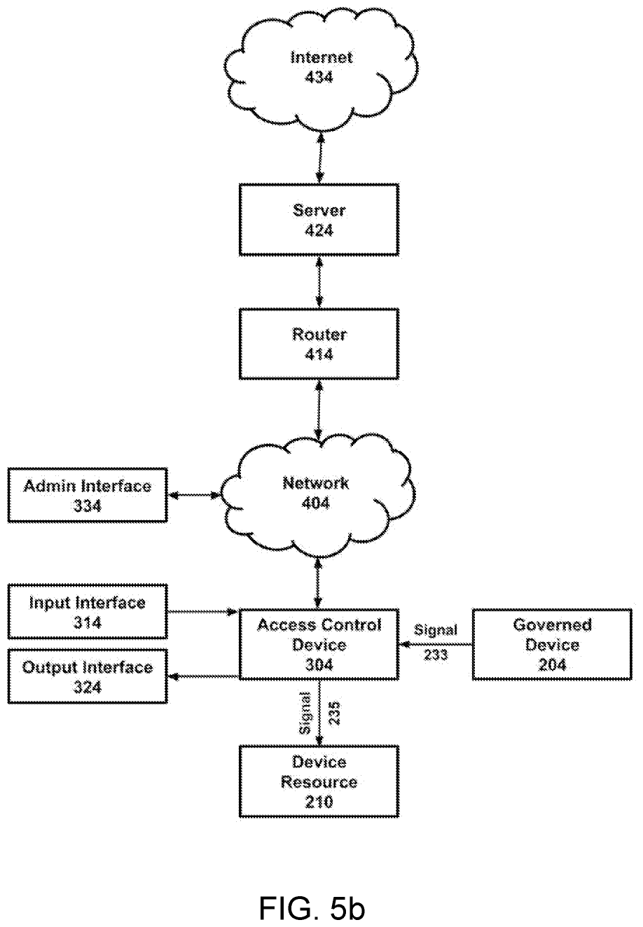

A user may easily circumvent the access control device (250) unless the design incorporates anti-circumvention features. Various examples of approaches to circumvention are now described, along with examples of the features incorporated into the design of the present disclosure that address user circumvention. It will be noted that the features presently described will not in all cases prevent circumvention. For example, in some cases the features may inhibit or discourage circumvention by detecting and reporting circumvention to an administrator. In other cases, in order to prevent circumvention, the features of the access control device must work in conjunction with the systems and methods shown in FIG. 5a and following, and described below.

CIRCUMVENTION #1: A user disconnects the power cord of the governed device (265) from the access control device (250), and connects the power cord of the governed device (265) to an unmanaged power source.

To detect this circumvention, the design of the present disclosure includes an AC plug detection circuit (263). When the AC plug of the governed device (265) is inserted into the AC power socket (264) of the access control device (250), the AC plug detection circuit (263) is closed. When the AC plug of the governed device (265) is removed from the AC power socket (264) of the access control device (250), the AC plug detection circuit (263) is open.

The software of the access control device (250) is programmed to interpret a closed AC plug detection circuit (263) as indicating that a governed device (265) is connected to the access control device (250). The software of the access control device (250) is programmed to interpret an open AC plug detection circuit (263) as indicating that a governed device (265) is not connected to the access control device (250).

The software of the access control device (250) may be programmed to take one or more actions when it interprets that the power cord of the governed device (265) has been connected to or removed from the access control device (250). These actions include, but are not limited to, recording the event in a database; reporting the event to the parental control system (100); communicating information about the event to an administrator, either directly or through the parental control system (100), either at the time of the event or at a later time; requiring intervention by an administrator to resume operation of the access control device (250); and/or activating an audible or visible notification, located either on the access control device (250), or on another device.

CIRCUMVENTION #2: A user disconnects the access control device (250) from the power source, for the purpose of accomplishing some circumvention undetected.

To detect this circumvention, the design of the present disclosure includes a supervisory circuit (261) capable of monitoring the electrical potential present across the line and neutral AC power inputs (267, 268) of the access control device (250). When the AC plug (251) of the access control device (250) is connected to a power source (266), the supervisory circuit (261) detects an electrical potential across the line and neutral power inputs (267, 268). When the AC plug (251) of the access control device (251) is disconnected from the power source (266), or in the event of a power failure, the supervisory circuit (261) detects the loss of the electrical potential across the line and neutral power inputs (267, 268).

The software on the access control device (250) is programmed to interpret the presence of an electrical potential across the line and neutral AC power inputs (267, 268), indicating that the access control device (250) is connected to the power source (266). The software of the access control device (250) is programmed to interpret the loss of electrical potential across the line and neutral AC power inputs (267, 268), indicating that the access control device (250) has been disconnected from the power source (266), or that a power failure has occurred.

In order to possess the capability of taking one or more actions when a user disconnects the access control device (250) from the power source (266), or when a power failure has occurred, the design of the present embodiment includes a backup power source (254). The backup power source (254) may or may not be of sufficient capacity to continue the operation of the AC plug detection circuit (263), wireless transceivers (257), microprocessor (258), or other components that detect Circumvention #1, or those components necessary to take actions in response to the detection of any circumvention, as described below.

If the backup power source (254) is of sufficient capacity to continue the operation of the AC plug detection circuit (263), wireless transceivers (257), and other components that detect Circumvention #1, as described above, then the disconnection of the access control device (250) from the power source (266) may be distinguished from a power failure. The software of the access control device (250) interprets the loss of input power followed by the opening of the AC plug detection circuit (263) as indicating that Circumvention #2 has been attempted. The software of the access control device (250) interprets the loss of input power while the AC plug detection circuit (263) remains closed as indicating power failure.

The software of the access control device (250) may be programmed to take one or more actions when the loss of electrical potential across the line and neutral AC power inputs (267, 268) is detected, whether due to circumvention or power failure. These actions include, but are not limited to, determining the nature of the event in light of other detected states or conditions, either at the time of the event or at a later time; recording the nature of the event in a database; reporting the event to the parental control system (100); communicating information about the event to an administrator, either directly or through the parental control system (100), either at the time of the event or at a later time; requiring intervention by an administrator to resume operation of the access control device (250); and/or activating an audible or visible notification, located either on the access control device (250) or on another device.

CIRCUMVENTION #3: Having gained access to the governed device (265) through the access control device (250), the user prevents communications between the access control device (250) and the router or a server. This action may be taken by a user in order to prevent the termination of access to the governed device (265) by the parental control system (100), or to prevent communications regarding use of the governed device (265) or attempted circumventions being sent from the access control device (250) to an administrator, or for some other purpose.

During operation of the governed device (265), the parental control system (100) may determine that the active user may no longer have access to the governed device (265). When such a determination is made, the parental control system (100) issues a command to the access control device (250) to cycle the power switch (262) to the “OPEN” state.

A user may attempt to prevent such termination of access by preventing communications between the access control device (250) and a router and/or server containing the parts of the parental control system (100) that determine that the active user may no longer have access to the governed device (265), and/or those parts of the parental control system (100) that may issue a command to the access control device (250) to cycle the power switch (262) to the “OPEN” state.

Attempts at Circumvention #3 may be classified in two categories. Category #3A includes attempts by a user to prevent communication between the access control device (250) and a router. Category #3B includes attempts to prevent communication between the router and a server. However, it should be understood that Circumvention #3 may be attempted in any way that prevents necessary communications between the access control device (250) and any part of the parental control system (100), regardless of how such prevention of communication is attempted.

If the connection between the access control device and the router is wireless, the user may attempt a Category #3A Circumvention by constructing a Faraday Cage around the access control device (250) and/or the router. Or the user may disable the wireless adapter (not shown) of the router. Or the user may disconnect the power to the router.

If the connection between the access control device (250) and the router is wired, the user may attempt a Category #3A Circumvention by disconnecting a data cable (not shown) at any point between the access control device (250) and the router. Or the user may disconnect the power to the router, or any other networking devices in the signal path (not shown).

If the connection between the router and the server is wired, the user may attempt a Category #3B Circumvention by disconnecting a data cable (not shown) at any point between the router and the server. Or the user may disconnect the power to the router, or any other networking devices in the signal path (not shown).

To limit the benefits to the user of Circumvention #3, the parental control system (100) may, at the time the user is granted access to the governed device (265), along with a command to cycle the power switch (262) to the “CLOSED” state, communicate to the part of the parental control system (100) located on the access control device (250) a maximum amount of time that the user may continue to access the governed device (265), or other parameters that may otherwise limit the ongoing access of the active user.

To prevent the success of Circumvention #3, the software of the access control device (250) may be programmed to send a signal at intervals via the wireless transceivers (257) to monitor ongoing connectivity to the router and/or server containing the parts of the parental control system (100) that determine that the active user may no longer have access to the governed device, and/or those parts of the parental control system (100) that may issue a command to the access control device (250) to cycle the power switch (262) to the “OPEN” state. The software of the access control device (250) may be programmed to interpret that Circumvention #3 has been attempted when a connection with the router and/or server has been terminated for a specified number of time intervals.

The software of the access control device (250) may be programmed to take one or more actions when it interprets that Circumvention #3 has been attempted. These actions include, but are not limited to, recording the event in a database; cycling the power switch (262) to the “OPEN” state, interrupting the delivery of power from the power source (266) to the governed device (265); reporting the event to the parental control system (100); communicating information about the event to an administrator, either directly or through the parental control system (100), either at the time of the event or at a later time; requiring intervention by an administrator to resume operation of the access control device (250); and/or activating an audible or visible notification, located either on the access control device (250) or on another device.

Circumvention by disconnecting the access control device can also, or alternatively, be prevented through a physical locking mechanism. Examples of such locking mechanisms are described in U.S. Pat. No. 5,731,763 by Herweck et al., the entire disclosure of which is incorporated herein for its teaching concerning locking mechanisms.

Circumvention by disconnecting the access control device can also, or alternatively, be prevented through the integration of the access control device into a replacement cord, such as described in United States Patent Pub. No. 2006/0176643, by Pecore, the entire disclosure of which is incorporated herein in its entirety.

FIG. 4b is a block diagram of an alternative exemplary design of an access control device (270) that enables a parent or other administrator to enforce a parental control policy (122) on a governed device (271) for one or more users by controlling the delivery of one or more electrical signals between the governed device (271) and a device resource (272) necessary for functional operation of the governed device (271), such as a television, display, projector, or A/V receiver, according to the method shown in FIG. 4b, and described below.

This alternative exemplary design includes an electrical input (277) and electrical output (279) suitable for transmission of electrical signals between a managed device (271) and a device resource (272). In one embodiment, the input (277) and output (279) are each HDMI ports, connected to the governed device (271) and the device resource (272) via HDMI cables (274a, 274b). This design also includes one or more switches (276) that pass or interrupt electrical signals between the governed device (271) and the device resource (272); a disconnection detection circuit (275) that monitors changes in voltage levels or other properties of one or more electrical signals to determine if the governed device (271) has been disconnected from the access control device (271); a microprocessor (258) for performing computing tasks; non-volatile memory (260) for storing software and data; wireless transceivers (257) for communicating with a wireless network and/or external wireless devices(s). The design further includes a DC voltage regulator (253) to provide the appropriate voltage and current supply to various device components.

The governed device (271) generates and transmits electrical signals via the HDMI cable (274a). These electrical signals may include power and/or a variety of different types of data signals, including video data, audio data, control data, or status data. These signals must be transmitted from the governed device (271) through the access control device (270) to one or more device resources (272) for the governed device (271) to be functionally operational. Device resources (272) may include televisions, video displays, A/V receivers, speakers, device controllers, or other data processing elements.

The parental control system (100) may be distributed among the access control device (250), the router (283), and/or one or more servers (281). The access control device (250) may communicate via the wireless transceivers (257) to other parts of the parental control system (100), e.g., a router (283), and/or server (281).

In one embodiment, the access control device (270) connects to a server (281) containing some or all of the parental control system (100) via its wireless transceivers (257), a wireless router (283), and a message broker server (282). In this network topology, there may, for example, be two types of network entities: a message broker (282) and one or more clients. In FIG. 4b, the server (281) containing some or all of the parental control system (100) and the access control device (270) are clients. The message broker (282) receives all messages originating from clients (known as the ‘publisher’), and routes these messages to the appropriate destination clients (known as the ‘subscriber(s)’).

Information is organized in a hierarchy of topics. When a client has a new item of data to publish, it sends a message with the data to the message broker. The message broker then distributes the information to any clients that have subscribed to that topic. The publisher does not need to have any information regarding the number or locations of subscribers, and subscribers in turn do not have to be configured with any information about the publisher.

In the present embodiment, the access control device (270) subscribes to various topics published by the server (281), allowing relevant server (281) data to be received by one or more connected access control devices (270). This data could include commands, firmware updates, authorization responses, server status, etc. As one example, the server (281) may send commands to one or more switches (276) to allow, prevent, or interrupt the flow of one or more electrical signals through the access control device (270). The server (281) will subscribe to topics to which an access control device (270) publishes, allowing the server (281) to receive data from an access control device (270). This data could include status, command responses, authorization requests, etc. One example of status data that an access control device (270) could send to the server (281) is the disconnection of the governed device (271) from the access control device (270), as determined by the disconnection detection circuit (275).

The access control device (270) is programmed to send ping request packets to the message broker (282) at regular intervals. This enables the message broker to monitor the connection status of the access control device (270). When a defined number of intervals have passed without receiving a ping request packet, the message broker (282) determines that a connection failure has occurred.

A connection failure may be the result of one or more factors, including but not limited to power loss, disabled or failed network connections, interruption of service, partial or total device failure, or device destruction. A connection failure may or may not be intentionally effected by a user for the purpose of circumvention.

The access control device (270) is also programmed to publish, upon initial connection to the message broker (282), a connection failure message to be released to the server (281), upon condition that the message broker (282) determines that its connection with the access control device (270) has been terminated. Until a connection failure is detected, the message broker (282) retains, but does not release, the connection failure message. Because connection failure messages are queued in the message broker (282), the parental control system (100) is reliably notified that it has lost connection with the access control device (270), even when the access control device (270) has lost connection to the network, has lost power, or has been destroyed.

A user provides information to the parental control system (100) satisfying conditions sufficient to gain access to the governed device (271). The parental control system (100) issues a command to the access control device (270) to cycle the switch (276) from the “OPEN” state to the “CLOSED” state. When the switch is in the “CLOSED” state, one or more electrical signals may be transmitted between the governed device (271) and the device resource (272) through the access control device (270).

During operation of the governed device (271), a signal monitor (256) monitors the delivery of one or more signals through the access control device (270) to the device resource (272). The presence of an ongoing signal is evaluated at intervals by software on the access control device (270) to determine whether the governed device (271) continues to operate, and communicates this determination to the parental control system (100). If it is determined that the governed device (270) has ceased to operate, the access control device may cycle the switch (276) to the “OPEN” state.

During operation of the governed device (271), the parental control system (100) may determine that the active user should no longer have access to the governed device (271). When such a determination is made, the parental control system (100) issues a command to the access control device (270) to cycle the switch (276) to the “OPEN” state.

A user may easily circumvent the access control device (270) of the present embodiment unless the design and systems incorporate anti-circumvention features and methods. Various examples of approaches to circumvention are now described, along with examples of the features and methods incorporated into the design of the present disclosure that address user circumvention. It will be noted that the features and methods presently described will not in all cases prevent circumvention. For example, in some cases the features may inhibit or discourage circumvention by detecting and reporting circumvention to an administrator. In other cases, in order to prevent circumvention the features of the access control device (270) must work in conjunction with the systems and methods shown in FIG. 5 and following, and described below.

Circumvention #4: A user disconnects the HDMI cable (274a) from the input (277) of the access control device (270), and connects the governed device (271) to the device resource (272). Alternatively or additionally, a user disconnects the HDMI cable (274a) from the governed device (271), and uses a separate HDMI cable to connect the governed device (271) to the device resource (272).

The disconnection detection circuit (275) monitors changes in voltage levels or content of one or more electrical signals. The software of the access control device (270) is programmed to interpret one or more changes, such as the unexpected loss of an electrical signal, as a disconnection event.

The software of the access control device (270) may be programmed to take one or more actions when it interprets that a disconnection event has occurred. These actions include, but are not limited to, recording the event in a database; reporting the event to the parental control system (100); communicating information about the event to an administrator, either directly or through the parental control system (100), either at the time of the event or at a later time; requiring intervention by an administrator to resume operation of the access control device (270); and/or activating an audible or visible notification, located either on the access control device (270), or on another device.

Circumvention #5: A user, being aware of the disconnection detection circuit (275) within the access control device (270), attempts to prevent the detection of user circumvention by disconnecting the access control device (270) from the power supply (273).

As described above, the access control device (270) is programmed to send ping request packets to the message broker (282) at regular intervals. When the access control device (270) is disconnected from the power supply (273), these ping request packets cease to be sent. After a defined number of intervals have passed without receiving a ping request packet, the message broker (282) determines that a connection failure has occurred, the message broker (282) releases the communication failure message to the parental control server (281)

The parental control system (100) may immediately or at a later time report the connection failure event to an administrator. The administrator will need additional information to determine that the connection failure event was attributable to power failure.

So in addition, the software of the access control device (270) may be programmed to take one or more actions when power loss has occurred. These actions include, but are not limited to, recording the power loss event in a database; communicating information about the power loss event to an administrator once power has been restored; reporting a subsequent re-connection of the power supply to an administrator either directly, or through the parental control system (100); upon re-connection of the power supply, activating an audible or visible notification, located either on the access control device (270) or on another device; and requiring intervention by an administrator after power loss to resume operation of the access control device (270).

Circumvention #6: Having gained access to the governed device (271) through the access control device (270), the user attempts to prevent communications between the access control device (270) and the router (283) or server (281). This action may be taken by a user in order to prevent the termination of access to the governed device (271) by the parental control system (100), or to prevent communications regarding use of the governed device (271) or attempted circumventions being reported from the access control device (270) to an administrator, or for some other reason.

During operation of the governed device (271), the parental control system (100) may determine that the active user may no longer have access to the governed device (271). When such a determination is made, the parental control system (100) issues a command to the access control device (271) to cycle the switch (276) to the “OPEN” state.

A user may attempt to prevent such termination of access by preventing communications between the access control device (270) and a router and/or server containing the parts of the parental control system (100) that determine that the active user may no longer have access to the governed device (271), and/or those parts of the parental control system (100) that may issue a command to the access control device (270) to cycle the switch (276) to the “OPEN” state.

Attempts at Circumvention #6 may be classified in two categories. Category #6A includes attempts by a user to prevent communication between the access control device (270) and a router (283). Category #6B includes attempts to prevent communication between the router (283) and a server (281). However, it should be understood that Circumvention #6 may be attempted in any way that prevents necessary communications between the access control device (270) and any part of the parental control system (100), regardless of how such prevention of communication is attempted.

If the connection between the access control device and the router is wireless, the user may attempt a Category #6A Circumvention by constructing a Faraday Cage around the access control device (270) and/or the router (283). Or the user may disable the wireless adapter (not shown) of the router (283). Or the user may disconnect the power to the router (283).

If the connection between the access control device (270) and the router (283) is wired, the user may attempt a Category #6A Circumvention by disconnecting a data cable (not shown) at any point between the access control device (270) and the router (283). Or the user may disconnect the power to the router (283), or any other networking devices in the signal path (not shown).

If the connection between the router (283) and the server (281) is wired, the user may attempt a Category #6B Circumvention by disconnecting a data cable (not shown) at any point between the router and the server. Or the user may disconnect the power to the router, or any other networking devices in the signal path (not shown).

To limit the benefits to the user of Circumvention #6, the parental control system (100) may, at the time the user is granted access to the governed device (271), along with a command to cycle the switch (276) to the “CLOSED” state, communicate to the part of the parental control system (100) located on the access control device (270) a maximum amount of time that the user may continue to access the governed device (271), or other parameters that may otherwise limit the ongoing access of the active user.

To prevent the success of Circumvention #6, the access control device (270) sends ping request packets to the message broker at regular intervals, as described above. When communications between the access control device (270) and the message broker (282) are interrupted at any point, these ping request packets cease to be received by the message broker (282). After a certain number of intervals, the message broker (282) determines that a communication failure has occurred. Once this determination has been made, the message broker (282) releases the communication failure message to the parental control server (281). The parental control system (100) may then immediately or at a later time report the communication failure to an administrator.

When communications between the access control device (270) and the message broker (282) are interrupted at any point, the ping request packets sent by the access control device (270) cease to be returned by the message broker (282). After a certain number of intervals, the access control device (270) determines that a communication failure has occurred.

The software of the access control device (270) may be programmed to take one or more actions when it interprets that a communication failure has occurred. These actions include, but are not limited to, recording the communication failure event in a database; cycling the switch (276) to the “OPEN” state, interrupting the delivery of an electrical signal from the governed device (271) to the device resource (272); reporting information about the communication failure event to an administrator via the parental control system (100) once communications have been restored; requiring intervention by an administrator to resume operation of the access control device (270); and/or activating an audible or visible notification, located either on the access control device (270) or on another device.

FIG. 4c is a block diagram of an alternative exemplary design of an access control device (270) that enables a parent or other administrator to enforce a parental control policy (122) on a governed device (271) for one or more users through control circuitry capable of detecting and controlling the operational state of a managed device.

This alternative exemplary design includes means of communication between the access control device (290) and the governed device (291). In one embodiment, the access control device (290) is connected to a governed device (291) via an HDMI cable (292). In this embodiment, the control circuitry is HDMI-CEC (Consumer Electronics Control).

This design also includes a microprocessor (258) for performing computing tasks; non-volatile memory (260) for storing software and data; wireless transceivers (257) for communicating with a wireless network and/or external wireless devices(s). The design further includes a DC voltage regulator (253) to provide the appropriate voltage and current supply to various device components.

By default, access to the managed device is blocked. At specified intervals (such as every 10 seconds), the microprocessor communicates with the managed device via HDMI-CEC. Such communications may include polling power state or connection status of the managed device. If in response to such polling, the managed device indicates that its power state is ‘ON’, the access control device issues a series of commands to the managed device to disable operation.

When access to the managed device has been granted according to the parental control policy, the access control device will allow the managed device to remain ‘ON’. The access control device may continue to monitor the presence of the managed device, as well as one or more operational states, and may record these states in an activity log.

Circumvention #7: A user attempts to circumvent the HDMI cable from between the access control device and the governed device.

In addition to the methods of detecting such attempt at circumvention described above (Circumvention #4), such circumvention may be detected through the communication protocols described above. The access control device polls the governed device for connectivity status or operational state. If the governed device is unresponsive for one or more intervals, the access control device may determine that the connection has been broken, and likely indicative of attempted circumvention.

In other respects, the operation of an access control device as shown in FIG. 4c is similar to that described in conjunction with FIGS. 4a and 4b.

### Access Control of a Governed Device

FIG. 5a is a block diagram of an exemplary embodiment of the systems and methods for digitally enforcing an access control policy (124) on a governed device (200) for one or more users by means of the access control device (300) of the present disclosure, shown in FIG. 4a.

A parent or other administrator desires to manage the access of one or more children and/or other users to a governed device (200) which requires a power source (230) for operation. Examples of such devices include, but are not limited to televisions, video game consoles, media streaming devices, desktop computers, and audio amplifiers. The power cord (231) of the governed device (200) is connected to the access control device (300) of the present disclosure. The access control device (300) is connected to the power source (230).

In some cases, such as battery-operated devices, there is no power cord (231) that connects the governed device (200) to the power source (230). In such cases, the access control device (300) would control the delivery of power between the battery or batteries and the governed device (200), with electrical connections being designed accordingly.

To gain access to the governed device (200), the child or other user provides their unique user identification and/or authentication to the parental control system (100) via one or more available user input interfaces (310, 311). Such user input interfaces (310, 311) may include, but are not limited to: an alphanumeric keypad; a keypad comprised of various shapes and/or colors; a touch screen detecting input of one or more shapes or patterns; a biometric input device capable of facial, fingerprint, or voice recognition; or a mobile smartphone. An input interface (310, 311) may be located on the access control device (300), or on a separate device. An input interface (310) may communicate to the parental control system (100) through the access control device (300). Alternatively, an input interface (311) may communicate to the parental control system (100) through the local area network (400), or some other network. These communications may happen via any available means, wired or wireless. Some or all of the parental control system (100) may be located on the access control device (300), the router (410), or one or more servers (420) accessible to the router (410) and access control device (300) through a wide area network (415). In this regard, the user input interfaces (310, 311) may comprise an authentication input device operative to receive an identification and/or authentication of a user.

The parental control system (100) receives a request from the user for access to the governed device (200). Through its various modules (110), the parental control system (100) identifies the access control policy (124) that governs the active user's access to the governed device (200). The conditions of the access control policy (124) may or may not be time-based. Under the conditions of the access control policy (124), the parental control system (100) evaluates whether the active user may be granted access to the governed device (200). If the active user may be granted access to the governed device (200), the parental control system (100) commands the access control device (300) to cycle its internal switch to the ‘CLOSED’ state, enabling power delivery from the power source (230) to the governed device (200).

The internal switch of the access control device (300) remains in the ‘CLOSED’ state (a) until the access control device (300) detects that the power of the governed device (200) has been cycled to the ‘OFF’ state, at which time the access control device (300) communicates to the parental control system (100) that the governed device (200) is no longer being operated by the active user; or, (b) so long as the parental control system (100) determines that the active user should continue to be granted access to the governed device (200) under the conditions of the parental control policy (122).

The parental control system (100) may record the amount of time that the active user operates the governed device (200) in an activity log (128) located in the database (120), or by other effective means. This may take place at defined intervals, or upon certain defined events, such as the access control device (300) detecting that the power of the governed device (200) has been cycled to the ‘OFF’ state. This data may be used by the evaluation module (114) or other modules (110) to decrement time available to the active user for the operation of the governed device (200), under the conditions of the access control policy (124).

As one example, an access control policy (124) may specify that a child has 60 minutes of time available to operate the governed device (200) each day. The child provides their unique user identification and/or authentication to the access control device (300) through an available user input interface (310). The parental control system (100) determines that the active user may be granted access to the governed device (200), and commands the access control device (300) to cycle its internal switch to the ‘CLOSED’ state. Power is now available for delivery from the power source (230) to the governed device (200) through the access control device (300). So long as the governed device (200) continues to operate, the access control device (300) communicates at one minute intervals to the parental control system (100) that the governed device (200) is still operating. This information is recorded in the activity log (128). When the active user has operated the governed device (200) for 60 minutes over the course of one day, the parental control system (100) determines that the active user may no longer be granted access to the governed device (200). The parental control system (100) commands the access control device (300) to cycle its internal switch to the ‘OFF’ state, preventing power delivery from the power source (230) to the governed device (200).

The parental control system (100) may also indicate various kinds of information to a user via one or more user output interfaces (320, 321) using one or more sensory means, including visual, aural, or tactile stimuli. Such communications may take place before, during, or after a user has accessed or operated the governed device (200). The parental control system (100) may communicate to an output interface (320) through the access control device (300). The parental control system (100) may also communicate to an output interface through the network (400), or some other network.

For example, during the process of a user attempting to gain access to a governed device (200), the parental control system (100) may indicate the status of this process through one or more output interfaces (320, 321). Also, during the period of operation, the parental control system (100) may indicate the status of the active user's ongoing access to the governed device (200) through an output interface (320, 321) using any effective means, including but not limited to: indicator lights, colors, symbols, alphanumeric characters, audio signals, or electro-mechanical vibrations.

FIG. 5b is a block diagram of an alternate exemplary embodiment of the systems and methods for digitally enforcing an access control policy (124) on a governed device (204) for one or more users by means of the access control device (304) of the present disclosure, shown in FIG. 4b. The systems and methods are similar to those described in conjunction with FIG. 5a, mutatis mutandis, summarized as follows.

A parent or other administrator desires to manage the access of one or more children and/or other users to a governed device (204) which requires a device resource (210) for functional operation. Examples of such governed devices include, but are not limited to video game consoles, media streaming devices, cable or satellite television decoders, disc players, and desktop computers. Examples of device resources (210) include but are not limited to televisions, video monitors, video projectors, and A/V receivers. The governed device (204) is connected to the access control device (304) of the present disclosure with a signal cable (233), such as an HDMI cable. The access control device (304) is connected to the device resource (210) with a signal cable (235), such as an HDMI cable. Alternatively, the access control device (304) could be built into the device resource (210). For example, if the device resource is a television, the access control device (304) could be incorporated into the design of the television.

To gain access to the governed device (204), the child or other user provides their unique user identification and/or authentication to the parental control system (100) via one or more available user input interfaces (314).

The parental control system (100) receives a request from a user for access to the governed device (204). If the parental control system (100) determines that the active user may be granted access to the governed device (204), the parental control system (100) commands the access control device (304) to cycle its internal switch to the ‘CLOSED’ state, enabling the transmission of one or more electrical signals from the governed device (204) to the device resource (210).

The internal switch of the access control device (304) remains in the ‘CLOSED’ state (a) until the access control device (304) detects that one or more signals from the governed device (204) are no longer present, at which time the access control device (304) communicates a signal or message to the parental control system (100) that the governed device (204) is no longer being operated by the active user; or, (b) so long as the parental control system (100) determines that the active user should continue to be granted access to the governed device (204) under the conditions of the parental control policy (122).

The parental control system (100) may record data indicating the amount of time that the active user operates the governed device (204) in an activity log (128) located in the database (120), or by other effective means. This may take place at defined intervals, or upon certain defined events, such as the access control device (304) detecting that the governed device (204) has ceased operation. This data may be used by the evaluation module (114) or other modules (110) to decrement time available to the active user for the operation of the governed device (204), under the conditions of the access control policy (124).

The parental control system (100) may also indicate various kinds of information to a user via one or more user output interfaces (324) using one or more sensory means, including visual, aural, or tactile stimuli. Such communications may take place before, during, or after a user has accessed or operated the governed device (204). The parental control system (100) may communicate to an output interface (324) through the access control device (304). The parental control system (100) may also communicate to an output interface through the network (400), or some other network.

FIG. 5c is a block diagram of an alternative exemplary embodiment of the systems and methods for digitally enforcing an access control policy (124) on a governed device (204) for one or more users by means of the access control device (304) of the present disclosure, shown in FIG. 4c. The systems and methods are similar to those described in conjunction with FIGS. 5a and 5b, mutatis mutandis, summarized as follows.

A parent or other administrator desires to manage the access of one or more children and/or other users to a governed device (204). Examples of such governed devices include, but are not limited to smart TV's, video game consoles, media streaming devices, cable or satellite television decoders. The governed device (204) is connected to the access control device (304) of the present disclosure with a signal cable (233), such as an HDMI cable.

To gain access to the governed device (204), the child or other user provides their unique user identification and/or authentication to the parental control system (100) via one or more available user input interfaces (314).

By default, access to the managed device is blocked. At specified intervals (such as every 10 seconds), the access control device communicates with the managed device via HDMI-CEC. Such communications may include polling power state or connection status of the managed device. If in response to such polling, the managed device indicates that its power state is ‘ON’, the access control device issues a series of commands to the managed device to disable operation. This could be a power state being ‘OFF’ or ‘STANDBY’.

The parental control system (100) receives a request from a user for access to the governed device (204). If the parental control system (100) determines that the active user may be granted access to the governed device (204), the parental control system (100) commands the access control device (304) to allow the governed device to be powered ‘ON’ without being disabled by the access control device.

Operation of the governed device is allowed until (a) the access control device (304) detects that the power state is ‘OFF’ or ‘STANDBY’, at which time the access control device (304) communicates a signal or message to the parental control system (100) that the governed device (204) is no longer being operated by the active user; or, (b) so long as the parental control system (100) determines that the active user should continue to be granted access to the governed device (204) under the conditions of the parental control policy (122).

The parental control system (100) may record data indicating the amount of time that the active user operates the governed device (204) in an activity log (128) located in the database (120), or by other effective means. This may take place at defined intervals, or upon certain defined events, such as the access control device (304) detecting that the governed device (204) has ceased operation. This data may be used by the evaluation module (114) or other modules (110) to decrement time available to the active user for the operation of the governed device (204), under the conditions of the access control policy (124).

The parental control system (100) may also indicate various kinds of information to a user via one or more user output interfaces (324) using one or more sensory means, including visual, aural, or tactile stimuli. Such communications may take place before, during, or after a user has accessed or operated the governed device (204). The parental control system (100) may communicate to an output interface (324) through the access control device (304). The parental control system (100) may also communicate to an output interface through the network (400), or some other network.

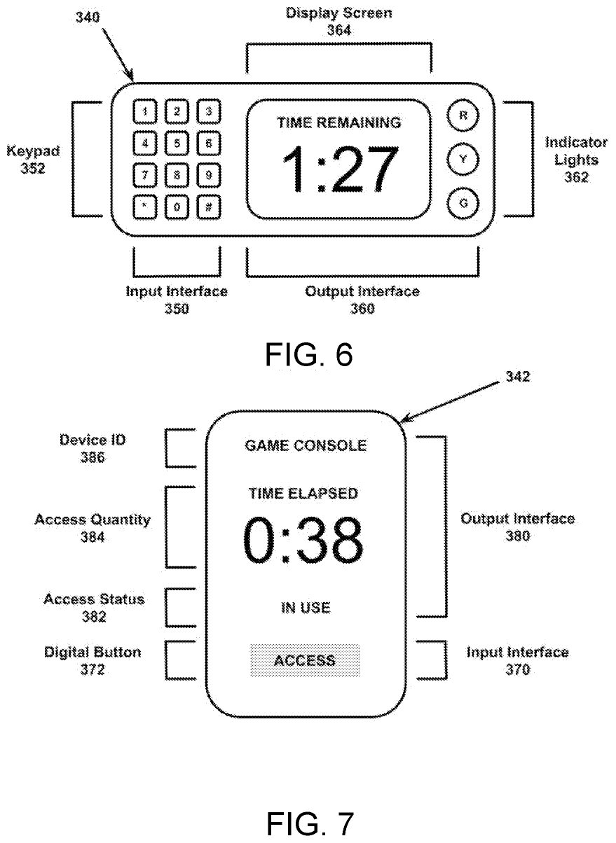

FIG. 6 shows an exemplary design (340) incorporating both input and output user interfaces. The input interface (350) enables a user to provide their unique user identification and/or authentication to the parental control system (100). The output interface (360) enables the user to receive communications from the parental control system (100). Such a design (340) could be incorporated in part or in whole into the access control device (300), or could be constructed separately in part or in whole as one or more additional devices.

In the exemplary design (340) of FIG. 6, a child or other user provides their user identification and/or authentication directly or indirectly to the parental control system (100) via a unique numeric passcode entered through the keypad (352). While the parental control system (100) is in the process of evaluating whether the active user may be granted access to the governed device (200), a yellow indicator light (362-Y) is activated. If access is denied, a red indicator light (362-R) is activated. If access is granted, a green indicator light (362-G) is activated. During the period of ongoing operation, the parental control system (100) may also indicate via a display screen (364) the quantity of access time elapsed or remaining.

FIG. 7 shows an exemplary alternate embodiment of a design whereby the input and output user interfaces are provided on a mobile computing device (342), such as a smartphone. An application compatible for use on the mobile computing device (342) may provide one screen containing both the input interface (370) and output interface (380), or multiple screens each containing some or all of the input interface (370) and/or output interface (380). The input interface (370) may include the means by which a user supplies their unique identification and/or authentication to the parental control system (100). The output interface (380) may include the means of the parental control system (100) indicating the status of the active user's access to the governed device (200), and/or any other information.

In the exemplary embodiment of FIG. 7, the user initiates a request to the parental control system (100) for access to the governed device (200) by activating a single digital button (372). Some mobile computing devices, such as mobile smartphones, enable this simplicity of operation because they are most often dedicated exclusively to a single user (“the owner”), with native security features that restrict device access to the owner. Having activated the digital button (372), the mobile computing device (342) may communicate wirelessly through any convenient protocol with the parental control system (100) either directly, or indirectly through the access control device (300).

The parental control system (100) may also indicate via the output interface (380) on the mobile computing device (342) the status of the active user's access to the governed device (200). Access status may be displayed on the output interface (380) through any number of means, including any combination of alphanumeric characters, shapes, and colors, either static or animated. In FIG. 7, access status (382) is indicated alphanumerically through the words, “IN USE”, but based on the access status at other times may display other appropriate words, such as “CONNECTING” or “OFF”. During the period of operation, the parental control system (100) may also indicate via the output interface (380) the quantity of the active user's access time elapsed or remaining (384). In some cases, such as when the active user has access to multiple managed devices, it may be desirable for the parental control system (100) to provide device identification (386) in conjunction with other information.

FIGS. 5a and 5b also include one or more administrator interfaces (330) that may communicate with the parental control system (100) through the local area network (400), or other networks. An administrator interface may include the ability to provide input to the parental control system (100), and to receive output from the parental control system (100). A parent or other administrator may access one or more administrator interfaces (330) through a web browser, computer applications, electronic messages, or any other available means.

An administrator interface (330) may enable a parent or other administrator to digitally define the conditions of the parental control policy (122), to initiate commands that affect a user's ability to operate one or more managed devices, or to send communications through the parental control system (100).

An administrator interface (330) may also enable the parental control system (100) to display information to the administrator. Such information may include notifications of attempts to circumvent the access control device (300), reports of activities attempted or accomplished by a user on a managed device, or requests from the user for temporary or permanent modifications to or suspension of the parental control policy (122).

### Content Control of a Governed Device

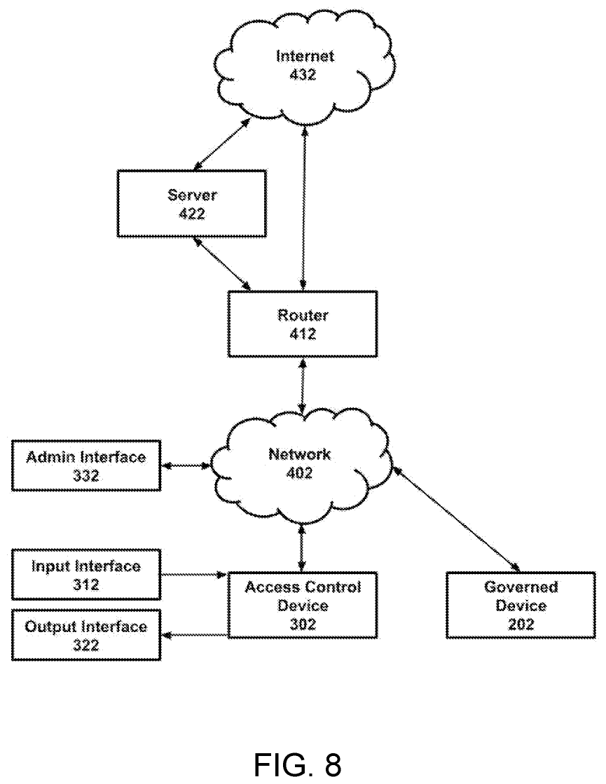

FIG. 8 is a block diagram of an exemplary embodiment of the systems and methods for digitally enforcing a content control policy (126) on a governed device (202) for one or more users by means of the access control device (302) of the present disclosure. The configuration of the access control device (302) relative to the governed device (202) may be according to the embodiments shown in FIG. 5a or 5b, or any other effective embodiment.

Computer-based devices may access content in whole or in part over the internet, and as such are typically configured to operate on a network. Some computer-based devices may be open or closed devices. Examples of computer-based devices that are typically closed devices include, but are not limited to, smart televisions, video game consoles and media streaming devices.

In the present systems and methods, the governed device (202) may be connected to the same network (402) as the access control device (302). Some of the parental control system (100) may be located on the access control device (302). Some or all of the parental control system (100) may be located on the router (412), or on one or more servers (422). The parental control system (100) is configured to associate communications to or from the governed device (202) with the active user of the supervising access control device (302). This may be accomplished through the use of the MAC address of the governed device (202), or any other effective means.

In one embodiment, the router (412) or governed device (202) is configured to direct requests from the governed device (202) to a server (422) containing those parts of the parental control system (100) necessary to enforce a content control policy (126) on the governed device (202). In another embodiment, the router (412) is configured to direct all communications from the network (402) to a server (422) containing those parts of the parental control system (100) necessary to enforce a content control policy (126) on the governed device (202). In another embodiment, the router (412) contains the parts of the parental control system (100) necessary to enforce a content control policy (126) on the governed device (202). The enforcement of a content control policy (126) may include, but is not limited to, recording activity in an activity log (128), and restricting the content that a child or other restricted user may access or share via the governed device (202).

A child or other restricted user gains access to operate the governed device (202) by means of the access control device (302), according to one of the methods described above in conjunction with FIGS. 5a, 5b, 6 and 7. Having been configured to associate the access control device (302) with communications to or from the governed device (202), the parental control system (100) associates any ensuing communications to or from the governed device (202) with the active user. The parental control system (100) monitors and/or restricts content accessed or shared by the governed device (202) over the internet (432) under the conditions of the content control policy (126) associated with the active user. The parental control system (100) may also record any communications to or from the governed device (202) in the activity log (128) of the active user. When the active user's access to the governed device (202) is terminated, either by the parental control system (100) or by the active user, the parental control system (100) ceases to associate with the active user any subsequent communications to or from the governed device (202).

The parental control system (100) recognizing communications to or from a governed device (202) through a router (412) or server (422) creates an additional safeguard against user circumvention. If no user has gained access to the governed device (202) via the access control device (302), but the governed device (202) is nevertheless sending or receiving communications, then a circumvention may have occurred. To definitively conclude that a circumvention has occurred, the parental control system (100) recognizes communications that a governed device (202) may make during sleep mode, such as automatic software updates.

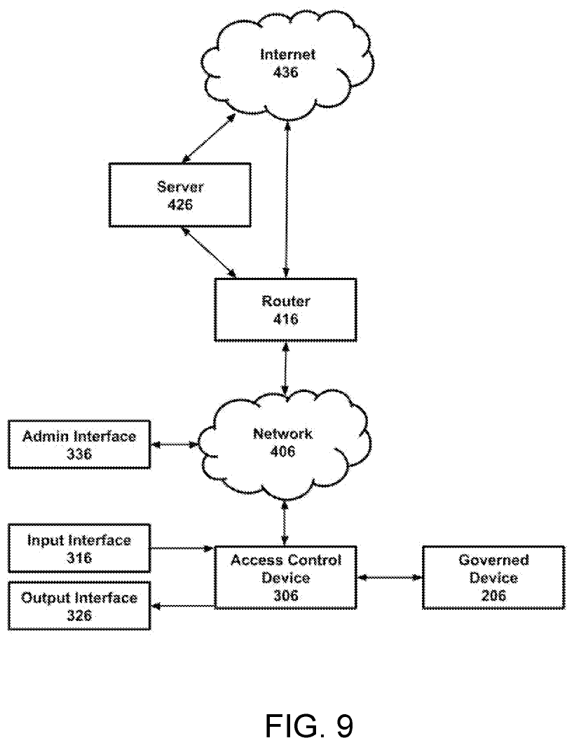

FIG. 9 is a block diagram of an alternate embodiment of the systems and methods for digitally enforcing a parental control policy (122) on a governed device (206) for one or more users by means of the access control device (306) of the present disclosure. One or ordinary skill in the art will recognize in view of this disclosure that the configuration of the access control device (306) relative to the governed device (206) may, for example, be according to the embodiments shown in FIG. 5a or 5b, or any other effective embodiment.

This embodiment may be used in conjunction with governed devices that require a connection to a computer network for operation. Such devices include but are not limited to media streaming devices, smart televisions, computers, and some functionality of video game consoles.

The data port of the governed device (206) is connected to the access control device (306). The data connection may be wired or wireless. The access control device (306) is connected to the network (406) or directly to the router (416). Some or all of the parental control system (100) is located on the access control device (306). Some of the parental control system (100) may also be located on the router (416), or on one or more servers (426). In this embodiment, the access control device (306) may alternately be incorporated into the physical design of the router (416).

In this embodiment, the content control policy (126) associated with the active user is enforced by monitoring and/or restricting the content that may be accessed or shared by the access control device (306). Moreover, the access control policy (124) associated with the active user may be enforced by restricting the delivery of a data signal, if the governed device (206) is wholly dependent upon access to data for functional operation, such as a media streaming device or smart television.

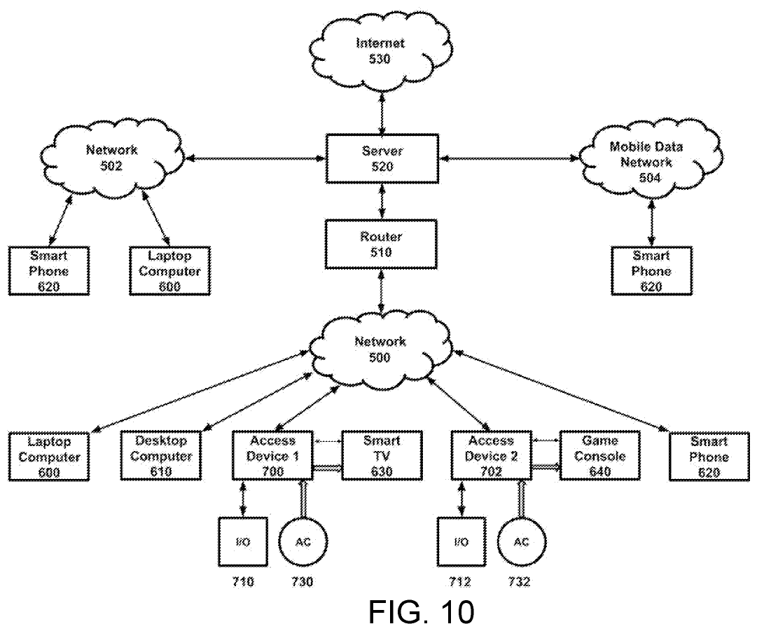

In other respects, the embodiment shown in FIG. 10 is similar in operation to the systems and methods shown in FIGS. 5a, 5b, 6, 7, and 8, described above.

FIG. 10 is a block diagram of an exemplary embodiment of the systems and methods of the present disclosure, whereby an administrator, such as a parent, may digitally enforce a parental control policy (122) for one or more users across any number of managed devices, whether closed devices or open devices. Some managed devices may access the internet exclusively over one network in the home, while others may access the internet over multiple networks inside and outside the home.

In this exemplary embodiment, a child has access to multiple open and closed devices. The open devices include a laptop computer (600), a desktop computer (610), and a mobile smartphone (620). The closed devices include a smart television (630) and a video game console (640).

The desktop computer (610), smart television (630), and video game console (640) access the internet exclusively over one network (500) in the home. The laptop computer (600) and mobile smartphone (620) may also access the internet over one or more additional networks (502) outside the home. Further, the mobile smartphone (620) may also access the internet over one or more cellular data networks (504).

The open devices (600, 610, 620) are configured as controlled devices. The closed devices (630, 640) are configured as governed devices, according to the embodiments shown in FIG. 5a and FIG. 9, and described above.

Some of the parental control system (100) is located on one or more servers (520), and some of the parental control system (100) is located on the open devices (600, 610, 620), and some of the parental control system (100) is located on the access control devices (700 and 702) governing the closed devices (630 and 640, respectively).

According to the embodiment shown in FIG. 10 and described above, access control device #1 (700) and the governed smart television (630) are configured so that the smart television (630) is dependent upon access control device #1 (700) for the delivery of power from a power source, (730) and for transmission of data to and from the network (500). In the same manner, access control device #2 (702) and the governed video game console (640) are configured so that the video game console (640) is dependent upon access control device #2 (702) for the delivery of power from a power source (732), and for transmission of data to and from the network (500).

A child gains access to each open device (600, 610, 620) through any available means whereby the specific child is identified to the parental control system (100). In the case of a device dedicated to the individual use of the child, such access may only require the child to cycle the power of the device to “ON”. In the case of an open device that is used by multiple users, each user including the child must have their own individual user account, that preferably requires a passcode or other access authentication. A child gains access to each closed device (630, 640) independently by providing the associated access control device (700 and 702, respectively) with their unique identification and/or authentication through the associated user input-output interface (710 and 712, respectively).

In this embodiment, the parental control system (100) enforces an access control policy (124) associated with a user across all managed devices that the user may operate. An access control policy may contain conditions that restrict user access to individual managed devices, and may contain conditions that restrict user access in the aggregate across multiple managed devices. The access control policy (124) is enforced on the controlled devices (600, 610, 620) directly by the parental control system (100). The access control policy (124) is enforced on the governed devices (630, 640) by controlling power delivery through the access control devices (700 and 702, respectively), according to the systems and methods shown in FIGS. 5a, 6, 7, and 9, and described above.

The parental control system (100) also enforces the content control policy (126) associated with the active user on all managed devices that the user may operate. The content control policy (126) is enforced on the controlled devices (600, 610, 620) directly by the parental control system. The content control policy (126) is enforced on the governed devices (630, 640) by monitoring and/or restricting the content that may be accessed or shared by the associated access control device (700 and 702, respectively), according to the systems and methods shown in FIGS. 5a, 6, 7, and 9, and described above.

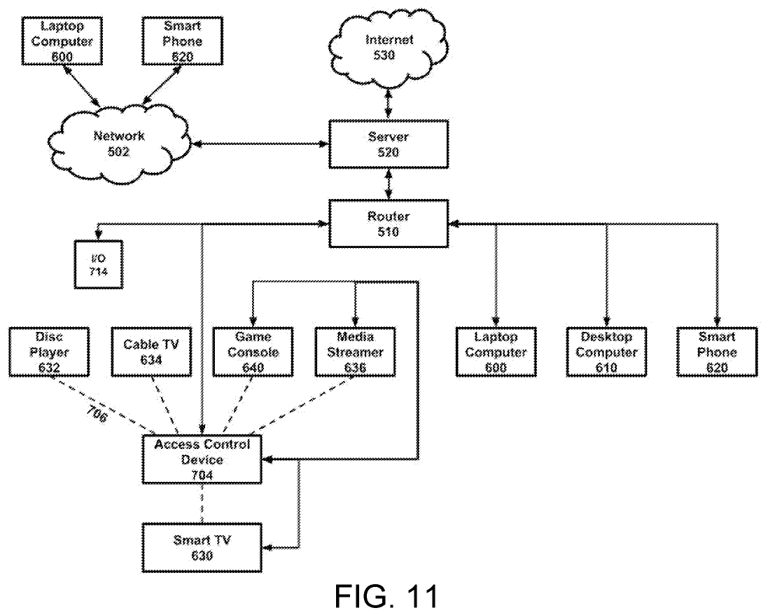

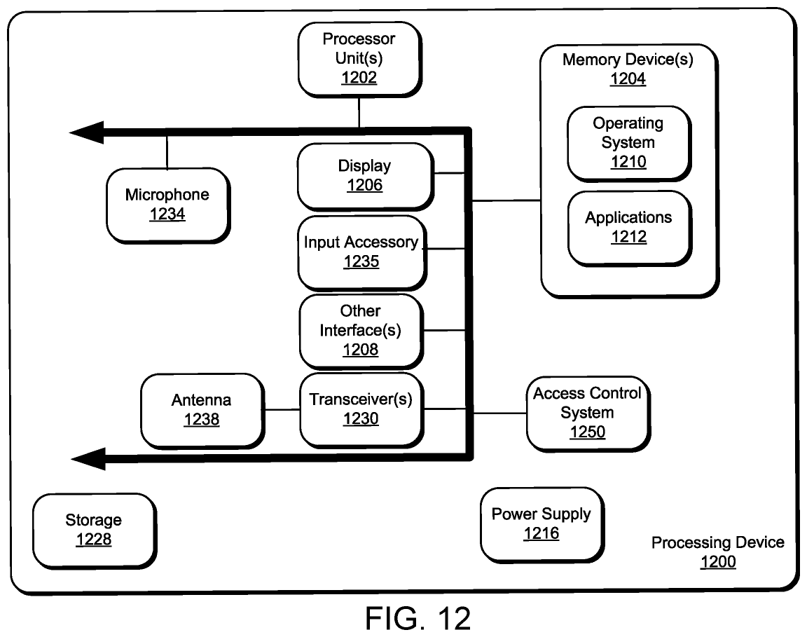

FIG. 11 is a block diagram of an exemplary alternative embodiment of the systems and methods of the present disclosure, whereby an administrator, such as a parent, may digitally enforce a parental control policy (122) for one or more users across any number of managed devices, whether closed devices or open devices. Some managed devices may access the internet exclusively over one network in the home, while others may access the internet over multiple networks inside and outside the home.

In this alternate exemplary embodiment, a child has access to multiple open and closed devices. The open devices include a laptop computer (600), a desktop computer (610), and a mobile smartphone (620). The closed devices include a smart television (630), video game console (640), media streaming device (636), cable television tuner (634), and a video disc player (632).

The desktop computer (610), smart television (630), video game console (640), and media streaming device (636) access the internet (530) exclusively over one network in the home, connected by a router (510). The laptop computer (600) and mobile smartphone (620) may also access the internet over one or more additional networks (502) outside the home. Further, the mobile smartphone (620) may also access the internet over one or more cellular data networks (not shown). The cable television tuner (634) and video disc player (632) do not access the internet.

The access control device (704) is constructed to accommodate at least four devices being connected by video signal cables (706), such as HDMI cables, in order to control access according to the embodiment shown in FIG. 8. The access control device (704) is constructed to accommodate at least one device being connected wirelessly in order to control access and restrict content according to the method shown in FIG. 9.

The open devices (600, 610, 620) are configured as controlled devices. The closed devices that require an external display (632, 634, 636, and 640) are configured as governed devices, according to the embodiments shown in FIGS. 5b and 8, described above. The closed device that does not require an external display (630) is configured as a governed device according to the embodiment shown in FIG. 9, described above.

Some of the parental control system (100) is located on one or more servers (520), and some of the parental control system (100) is located on the open devices (600, 610, 620), and some of the parental control system (100) is located on the access control device (704) governing the closed devices (630, 632, 634, 636, and 640).

A child gains access to each open device (600, 610, 620) through any available means whereby the specific child is identified to the parental control system (100). In the case of a device dedicated to the individual use of the child, such access may only require the child to cycle the power of the device to “ON”. In the case of an open device that is used by multiple users, each user including the child must have their own individual user account, that preferably requires a passcode or other access authentication. A child gains access to each closed device (630, 632, 634, 636, and 640) independently by providing the access control device (704) with their unique identification and/or authentication through the user input-output interface (714).

In this embodiment, the parental control system (100) enforces an access control policy (124) associated with a user across all managed devices that the user may operate. An access control policy may contain conditions that restrict user access to individual managed devices, and may contain conditions that restrict user access in the aggregate across multiple managed devices. The access control policy (124) is enforced on the controlled devices (600, 610, 620) directly by the parental control system (100). The access control policy (124) is enforced on the governed devices that require an external display (632, 634, 636, and 640) by controlling the transmission of a video signal through the access control device (704), according to the systems and methods shown in FIGS. 5b, 6, 7, and 8. The access control policy (124) is enforced on the Smart TV (630) by controlling the transmission of a data signal through the access control device according to the systems and methods shown in FIGS. 5b, 6, 7, and 9.

The parental control system (100) also enforces the content control policy (126) associated with the active user on all managed devices that the user may operate. The content control policy (126) is enforced on the controlled devices (600, 610, 620) directly by the parental control system. The content control policy (126) is enforced on the governed devices (630, 632, 634, 636, and 6400) by monitoring and/or restricting the content that may be accessed or shared by the access control device (704), according to the systems and methods shown in FIGS. 5a, 6, 7, 8, and 9, and described above.

FIG. 12 illustrates an example schematic of a processing device 1200 suitable for implementing aspects of the disclosed technology including any one or more components of an access control system 1250 according to the general description provided above. The processing device 1200 includes one or more processor unit(s) 1202, memory 1204, a display 1206, and other interfaces 1208 (e.g., buttons). The memory 1204 generally includes both volatile memory (e.g., RAM) and non-volatile memory (e.g., flash memory). An operating system 1210, such as the Microsoft Windows® operating system, the Apple macOS operating system, or the Linux operating system, resides in the memory 1204 and is executed by the processor unit(s) 1202, although it should be understood that other operating systems may be employed.

One or more applications 1212 are loaded in the memory 1204 and executed on the operating system 1210 by the processor unit(s) 1202. Such applications 1212 may include any one or more of the modules 110 described above in relation to the system 100. Applications 1212 may receive input from various input local devices such as a microphone 1234, input accessory 1235 (e.g., keypad, mouse, stylus, touchpad, joystick, instrument mounted input, or the like). Additionally, the applications 1212 may receive input from one or more remote devices such as remotely-located smart devices by communicating with such devices over a wired or wireless network using more communication transceivers 1230 and an antenna 1238 to provide network connectivity (e.g., a mobile phone network, Wi-Fi®, Bluetooth®). The processing device 1200 may also include various other components, such as a positioning system (e.g., a global positioning satellite transceiver), one or more accelerometers, one or more cameras, an audio interface (e.g., the microphone 1234, an audio amplifier and speaker and/or audio jack), and storage devices 1228. Other configurations may also be employed.

The processing device 1200 further includes a power supply 1216, which is powered by one or more batteries or other power sources and which provides power to other components of the processing device 1200. The power supply 1216 may also be connected to an external power source (not shown) that overrides or recharges the built-in batteries or other power sources.

In an example implementation, a display system may include hardware and/or software embodied by instructions stored in the memory 1204 and/or the storage devices 1228 and processed by the processor unit(s) 1202. The memory 1204 may be the memory of a host device or of an accessory that couples to the host.

The processing device 1200 may include a variety of tangible processor-readable storage media and intangible processor-readable communication signals. Tangible processor-readable storage can be embodied by any available media that can be accessed by the processing device 1200 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing device 1200. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. An administrative control system, comprising:
an access control device (ACD) comprising:
electrical connectors for electrically inserting the ACD into an electrical circuit of one or more governed devices,
access circuitry that controls flow of electricity through the electrical connectors for controlling the flow of electricity through the electrical circuit,
a computing device electronically connected to the access circuitry; and
a network connection operationally connecting the computing device of the ACD to a computer network comprising one or more network computing devices; and
an access module comprising software executing on at least one of the computing device of the ACD or the one or more network computing devices to control the access circuitry.

2. The system of claim 1, further comprising:
an authentication input device, wherein at least one of the computing device of the ACD or the one or more network computing devices are programmed to control access to a governed device in response to an input to the authentication input device.

3. The system of claim 2, wherein the authentication input device is selected from the group consisting of a camera, a keypad, a touch screen, a biometric input device, a computer, a mobile phone, or a smartphone.

4. The system of claim 2, wherein:
the authentication input device accepts facial, fingerprint, or voice data as the input, and
the access module interprets the facial, fingerprint, or voice data and to control the access circuitry based on the facial, fingerprint, or voice data.

5. The system of claim 2, wherein:
the authentication input device accepts visual data from an individual of a group of individuals as the input; and
the access module is operative to:
interpret the visual data to identify the individual as a user of a governed device, and
control the access circuitry based on the identification of the individual as the user of the governed device.

6. The system of claim 2, wherein:
the authentication input device accepts as input visual data from at least one individual of a group of individuals; and
the access module is operative to:
interpret the visual data to identify one or more of the group of individuals accessing a governed device; and
log user activity based on the identification of the one or more of the group of individuals accessing the governed device.

7. The system of claim 2, wherein the access module is operative to:
receive a request from a user for access to a governed device; and
determine, pursuant to an access control policy, whether the user is to be granted access to the governed device; and
if the determination pursuant to the access control policy is that the user is to be granted access to the governed device, command the ACD to cycle a switch of the access circuitry to an enabling state enabling transmission of one or more electrical signals to the governed device.

8. The system of claim 7, wherein the transmission of the one or more electrical signals to the governed device comprises transmission of the one or more electrical signals between the governed device and a device resource.

9. The system of claim 7, wherein the access module is operative to:
command the access circuitry to cycle the switch to the enabling state enabling the transmission of the one or more electrical signals to the governed device; and
permit the switch of the ACD to remain in the enabling state until the ACD detects that the one or more electrical signals from the governed device is no longer present; and
when the one or more electrical signals from the governed device is no longer present, communicate to the one or more of the network computing devices a message indicating that the governed device is no longer being operated by the user.

10. The system of claim 9, wherein the access module is operative to permit the switch of the ACD to remain in the enabling state enabling the transmission of the one or more electrical signals to the governed device until the conditions of a control policy determine that user access is no longer authorized.

11. The system of any one of claims 2-5, wherein the access module is operative to monitor content and enforce a content control policy for any or all of one or more of a plurality of governed devices.

12. The system of claim 11, wherein enforcing the content control policy comprises the access module:
identifying a user of the governed device;
monitoring content of the governed device; and
evaluating the content relative to the identified user to determine whether the user is authorized by the content control policy to access the content; and
denying access to unauthorized content not authorized by the content control policy for the user.

13. The system of claim 11, wherein the access module is operative to enforce the content control policy and an access control policy specific to an identified user.

14. The system of claim 1, further comprising a plurality of governed devices.

15. The system of claim 1, wherein the one or more governed devices each comprise an open device.

16. The system of claim 1, wherein the one or more governed devices each comprise a closed device.

17. The system of claim 1, wherein the one or more governed devices include at least one open device and at least one closed device.

18. The system of claim 1, comprising a plurality of ACDs, each electrically inserted via the electrical connectors into respective electrical circuits of a corresponding plurality of governed devices.

19. The system of any one of claim 1 or 2, further comprising:
circumvention monitoring circuitry operationally coupled to at least one of the computing device of the ACD or the one or more network computing devices, the circumvention monitoring circuitry configured to monitor for a circumvention state of the ACD.

20. The system of claim 19, wherein the access module is operative to transmit a message to an administrator when the circumvention state of the ACD has been detected by the circumvention monitoring circuitry.

21. The system of claim 19, wherein the circumvention comprises disconnection of ACD power.

22. The system of claim 19, wherein the circumvention comprises interruption of a network connection of the system.

23. The system of claim 19, wherein the circumvention comprises disconnection of one or more of the electrical connectors of the system.

24. The system of claim 1, wherein the access module is operative to monitor data traffic through a data access point for a governed device and communicate that a circumvention state has occurred if data traffic is detected to or from the governed device when no user has gained access via the ACD.

25. The system of claim 1, wherein the access module is operative to detect an operational state of the governed device and issue control commands that disable operation of the governed device.

26. The system of claim 25, wherein the control commands comprise a command that enables or disables operation of the governed device based on a control policy.

27. The system of claim 26, wherein the control commands that enable or disable operation of the governed device based on the control policy cause the governed device enter a power state of OFF.

28. The system of claim 26, wherein the control commands that enable or disable operation of the governed device based on the control policy cause the governed device enter a power state of STANDBY.

29. The system of claim 1, wherein the access module is operative to poll a governed device for connectivity status or operational state.

30. The system of claim 29, wherein the access module is further operative to:
determine whether the polled governed device is unresponsive for a predetermined interval; and
if the polled governed device is unresponsive for the predetermined interval, to make a determination of probable circumvention.

31. The system of claim 30, wherein if at least one of the computing device of the ACD or the one or more network computing devices makes the determination of the probable circumvention, the at least one of the computing device of the ACD or the one or more network computing devices causes a message indicating the probable circumvention to be transmitted to at least one of a user or administrator.

32. The system of claim 1, wherein the ACD is provided as part of a device resource.

33. The system of claim 32, wherein the ACD is provided as part of a television.

34. The system of claim 1, wherein the ACD is provided as a stand-alone device, separate from any governed device or device resource.

35. A method of controlling access to a governed device, the method comprising:
electrically inserting an access control device (ACD) via electrical connectors into an electrical circuit of a governed device;
operationally connecting a computing device of the ACD to a computer network via a network connection of the ACD; and
executing an access module access module comprising executing software on at least one of the computing device of the ACD or the one or more network computing devices for enforcing an access control policy for the governed device; and
controlling flow of electricity through the electrical connectors by access circuitry of the ACD for controlling the flow of electricity through the electrical circuit in response to the enforcing the access control policy for the governed device.

36. The method of claim 35, further comprising:
switching the access circuitry between an on access state and an off access state for the governed device based on the control policy.

37. The method of claim 35, further comprising:
switching the access circuitry between an on access state and an off access state for the governed device based on user access input.

38. The method of claim 35, further comprising:
polling the governed device for at least one of a connectivity status or operational state; and
if the polled governed device is unresponsive for one or more polling intervals, making a determination of probable circumvention; and
causing a message indicating the probable circumvention to be transmitted to an administrator.

39. The method of claim 35, further comprising:
identifying a circumvention state indicating circumvention of the electrical circuit; and
responding to the circumvention state by one or more of the following:
recording the circumvention state in a database;
reporting the circumvention state to an administrative control system;
sending a communication about the circumvention state to an administrator;
requiring intervention by an administrator to resume operation of the ACD; or
activating an audible or visible notification at the ACD.

40. The method of claim 35, further comprising:
responding to a circumvention state indicating circumvention of the electrical circuit by deactivating the ACD; and
requiring administrator intervention to reactivate the ACD.

41. An administrative control system, comprising:
an access control device (ACD) comprising a computing device;
a network connection operationally connecting the computing device of the ACD to a computer network comprising one or more network computing devices; and
an access module access module comprising executing software on at least one of the computing device of the ACD or the one or more network computing devices programmed to cause transmission of a control command to a governed device that enables or disables operation based on a control policy.
